(19) United States
(12) Patent Application Publication
(10) Pub. No.: US 2015/0153897 A1
(43) Pub. Date: Jun. 4, 2015

(54) USER INTERFACE ADAPTATION FROM AN INPUT SOURCE IDENTIFIER CHANGE

(71) Applicant: Microsoft Corporation, Redmond, WA (US)

(72) Inventors: Jerry Huang, Beijing (CN); Zhen Liu, Redmond, WA (US)

(73) Assignee: Microsoft Corporation, Redmond, WA (US)

(21) Appl. No.: 14/094,916

(22) Filed: Dec. 3, 2013

(51) Int. Cl. G06F 3/041; G06F 3/033

(52) U.S. Cl. CPC G06F 3/0418; G06F 3/033

(57) ABSTRACT

User Interface Adaptation (UIA) code adapts user interfaces using input source identifiers, touch area size categories, and user interface components. Input source changes are detected by querying an operating system, checking device drivers, noting that touch area sizes crossed a threshold, or by user command. Adaptation includes disabling and/or enabling user interface components, thereby changing font size, layout, shape, and/or component display size. Changes between a mouse and a finger, or between adult fingers and child fingers, or between elastic and inelastic input sources, are some examples of input source changes. Some contact areas are circular, quadrilateral, or irregular, and defined in terms of vertex points, center, radius, or bitmaps, using one or more touch locations, previously specified values, offsets from touch locations, tracings, averages, or weighted averages. Some embodiments calibrate the touch area size categories. UIA code resides in an operating system, in an application, or both.

### COPYRIGHT AUTHORIZATION

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### RELATED APPLICATIONS

Portions of the present application's disclosure overlap with the following concurrent applications: RESOLVING AMBIGUOUS TOUCHES TO A TOUCH SCREEN INTERFACE (Docket No. 339580.01), and CONTROLLING INTERACTIONS BASED ON TOUCH SCREEN CONTACT AREA (Docket No. 340154.01).

### BACKGROUND

Many devices and systems include a two-dimensional display screen, such as a plasma display, liquid crystal display, electronic ink display, computer monitor, video display, head-mounted display, organic light-emitting diode display, haptic screen, or other component which displays a user interface. Like other lists herein, this list of example display technologies is merely illustrative, not exhaustive. Research into display technologies is on-going; current research interests include carbon nanotube, quantum dot, and other display technologies.

Some display screen technologies are “touch” screen technologies, which means they provide electronic information (in analog and/or digital form) about physical contact between a pointing device and a touch screen. The pointing device may be a stylus or a user's finger, to name just two examples. Many pointing devices, such as a mouse or joystick, can be used to interact with a device or system regardless of whether a touch screen is present. When a touch screen is present, the electronic information provided about physical contact between a given pointing device and the touch screen usually includes at least one contact point coordinate. In some cases, the electronic information also includes a pressure value. For example, some pen pointing devices transmit a pressure reading indicating how hard a user is pressing the pen against a display screen.

All of these display technologies have the ability, or prospective ability, to display a user interface. A wide variety of user interface choices exist. One choice is between textual command-line interfaces, for example, and graphical interfaces. Textual interfaces and graphical interfaces may also be integrated with a voice-controlled interface, a computer-vision-based motion sensing interface, or another interface. Within the realm of graphical user interfaces (GUIs), many choices also exist, with regard to individual icons, item organization on the screen, mechanisms for navigating through menus, mechanisms for navigating through files, historic interaction data, different widgets (radio buttons, sliders, etc.), whether to use windows, which actions to animate and how to animate them, how to size buttons and other displayed items, how to layout displayed items, and so on.

Display screens are present in a wide range of devices and systems, which are intended for various uses by different kinds of users. Some of the many examples include computer tablets, smartphones, kiosks, automatic teller machines, laptops, desktops, and other computers, appliances, motor vehicles, industrial equipment, scientific equipment, medical equipment, aerospace products, farming equipment, mining equipment, and commercial manufacturing or testing systems, to name only a few.

In summary, a great many factors can impact user interactions with a device or system, ranging from hardware factors (e.g., what display technology is used) to design and market factors (e.g., who the expected users are, and what they hope to achieve using the device or system). One of skill would thus face an extremely large number of choices when faced with the challenge of improving user interaction with a device or system that has a display.

### SUMMARY

Some embodiments address technical problems such as how to efficiently and effectively utilize screen real estate in light of the kind of input device (mouse, finger, etc.) being used. Some embodiments include User Interface Adaptation (UIA) code to adapt a user interface in response to an input source change, e.g., through dynamic GUI resizing. In some embodiments UIA code resides in an application program, and in some it is split between the operating system and the application(s).

As an example, assume a user interface is displayed on a touch-responsive screen. Some embodiments provide at least two input source identifiers and at least two user interface components. Some link each of the input source identifiers with a respective user interface component in a memory. The embodiment detects an input source change, from a first input source identifier linked with a first user interface component to a second input source identifier linked with a second user interface component. In response, the embodiment adapts the user interface by disabling a first user interface component which is linked with the first input source identifier and not linked with the second input source identifier, and/or by enabling a second user interface component which is not linked with the first input source identifier and is linked with the second input source identifier.

In some embodiments, the first input source identifier does not identify any input source that is identified by the second input source identifier, the first input source identifier identifies a digit as an input source (“digit” means at least one finger or at least one thumb), and the second input source identifier identifies at least one of the following pointing devices as an input source: a mouse, a pen, a stylus, a trackball, a joystick, a pointing stick, a trackpoint, or a light pen.

Some embodiments adapt the user interface in response to two consecutive inputs, and one of the following conditions is satisfied. Under a first condition, one input is from a digit and the other input is from a mouse, a pen, a stylus, a trackball, a joystick, a pointing stick, a trackpoint, or a light pen pointing device. Under the second condition, one input is from an adult's digit and the other input is from a child's digit.

In some embodiments, the first input source identifier identifies an input source which is elastic, and the second input source identifier identifies an input source which is not elastic. In some embodiments, “elastic” means producing touch areas of at least three different sizes which differ from one another in that each of the sizes except the smallest size is at least 25% larger than another of the sizes. In other embodiments, elastic is defined differently, e.g., based on another percentage difference in sizes or on an absolute difference in sizes defined by an area size threshold.

In some embodiments, detecting an input source change made by a user includes querying an operating system to determine a currently enabled input source. Some embodiments check which device driver is configured in the device to supply input. Some keep a history of recent area sizes and ascertain that a sequence of at least two touch area sizes has crossed a predefined touch area size threshold. Some can receive through the user interface a command given by the user which specifically states a change to a different input source identifier. For example, an adult user may command the device to adapt itself for use by a child.

Some embodiments adapt the user interface at least in part by changing between a user interface component that has a text font size designed for use with a precise pointing device as the input source and a user interface component that has a text font size designed for use with a digit as the input source. Some adapt the user interface at least in part by changing a user interface component layout, and some adapt the user interface at least in part by changing a user interface component shape or size.

Some embodiments provide at least two touch area size categories, at least two input source identifiers, and at least two user interface components. They affiliate each of the at least two input source identifiers with a single respective touch area size category, and associate each of the at least two user interface components with at least one touch area size category. They detect an input source change, from a first input source identifier affiliated with a first touch area size category to a second input source identifier affiliated with second touch area size category. In response, they adapt the user interface by disabling a first user interface component which is associated with the first touch area size category and not with the second touch area size category, and/or by enabling a second user interface component which is not associated with the first touch area size category and is associated with the second touch area size category.

Some embodiments calibrate the touch area size categories. Calibration includes obtaining at least one sample contact area and applying the sample contact area(s) as calibration input(s).

Some embodiments calculate the contact area size by utilizing at least one of the following representations of the contact area: a circular area, a rectangular area defined using four vertex points, a quadrilateral area defined using four vertex points, a convex polygonal area having vertex points, a bitmap, or a set of discrete points inside the contact area (the boundary is included, so points “inside” may be on the boundary). Some embodiments calculate the contact area size utilizing a representation of the contact area as a circular area having a center and a radius, and assign one of the following values as the center: a touch location, a predefined offset from a touch location, or an average of multiple touch locations. Some embodiments assign one of the following values as the radius: a radius value specified by a user setting, a radius value specified by a default setting, or a computational combination of multiple distance values which are derived from multiple touch locations.

The examples given are merely illustrative. This Summary is not intended to identify key features or essential features of the claimed subject matter, nor is it intended to be used to limit the scope of the claimed subject matter. Rather, this Summary is provided to introduce—in a simplified form—some technical concepts that are further described below in the Detailed Description. The innovation is defined with claims, and to the extent this Summary conflicts with the claims, the claims should prevail.

### DESCRIPTION OF THE DRAWINGS

A more particular description will be given with reference to the attached drawings. These drawings only illustrate selected aspects and thus do not fully determine coverage or scope.

FIG. 1 is a block diagram illustrating a computer system or device having at least one display screen, and having at least one processor and at least one memory which cooperate with one another under the control of software for user interaction, and other items in an operating environment which may be present on multiple network nodes, and also illustrating configured storage medium embodiments;

FIG. 2 is a block diagram which builds on FIG. 1 to illustrate some additional aspects of ambiguous touch resolution in an example user interaction architecture of some embodiments;

FIG. 3 is a block diagram which builds on FIG. 1 to illustrate some additional aspects of touch-area-based interaction in another example architecture of some embodiments;

FIG. 4 is a block diagram which builds on FIG. 1 to illustrate some additional aspects of user interface adaptation interaction in yet another example user interaction architecture of some embodiments;

FIG. 5 is a diagram illustrating some aspects of user interaction with a touch screen, and showing in particular a circular representation of a touch area in some embodiments (touch area is also referred to herein as “contact area”);

FIG. 6 is a diagram which builds on FIG. 5 to illustrate a multiple point representation of a touch contact area in some embodiments;

FIG. 7 is a diagram which builds on FIG. 5 to illustrate a quadrilateral representation of a touch contact area in some embodiments;

FIG. 8 is a diagram which builds on FIG. 5 to illustrate a first example of a polygonal representation of a touch contact area in some embodiments;

FIG. 9 is a diagram which builds on FIG. 5 to illustrate a second example of a polygonal representation of a touch contact area in some embodiments;

FIG. 10 is a diagram which builds on FIG. 5 to illustrate an example of an ambiguous touch contact area and several user interface components in some embodiments;

FIG. 11 is a diagram which builds on FIG. 10 to illustrate an ambiguous touch contact area in some embodiments, utilizing a circular representation which overlaps two candidate user interface components;

FIG. 12 is a diagram which also builds on FIG. 10 to illustrate an ambiguous touch contact area in some embodiments, again utilizing a circular representation which overlaps two candidate user interface components, wherein the circular representation is calculated from multiple touch locations;

FIG. 13 is a diagram which also builds on FIG. 10 to illustrate a resolution menu displayed in some embodiments in response to an ambiguous touch;

FIG. 14 is a diagram illustrating functions that monotonically relate touch area to magnitude in some embodiments; in this example the magnitude is interpreted directly as a pressure value, and the functions are calibrated using a single sample point;

FIG. 15 is another diagram illustrating functions that monotonically relate touch area to a magnitude in some embodiments; the magnitude is again interpreted directly as a pressure value, but the functions are calibrated using two sample points;

FIG. 16 is a diagram illustrating control of an interactive depth variable in some embodiments, using a touch gesture on a screen which changes both position and touch area;

FIG. 17 is a diagram illustrating control of an interactive line width variable in some embodiments, using a touch gesture on a screen which changes both position and either touch area or actual pressure;

FIG. 18 is a diagram illustrating control of an interactive flow variable based on a pressure velocity in some embodiments, contrasting actual screen touch area with a resulting ink flow or paint flow;

FIG. 19 is a calligraphic character further illustrating control of an interactive line width variable in some embodiments;

FIG. 20 is a diagram illustrating a first arrangement of user interface components in some embodiments;

FIG. 21 is a diagram which builds on FIG. 20 to illustrate another arrangement of user interface components, produced though an adaptive response to a change in an input source identifier; and

FIGS. 22 through 25 are flow charts illustrating steps of some process and configured storage medium embodiments.

### DETAILED DESCRIPTION

Overview

As noted in the Background section, a great many factors can impact user interaction with a device or system, ranging from hardware factors to design and market factors. Without the benefit of hindsight, one of skill would thus be quite unlikely to devise the particular innovations described herein, due to the extremely large number of options to first categorize as relevant/irrelevant and then work through to arrive at the particular solutions presented here. However, with the benefit of hindsight (that is, already knowing the particular innovations described herein), some technical factors do have particular interest here. These factors include, for example, whether a touch screen is present, what electronic information is provided about contact between a pointing device and a touch screen, and which pointing device is used to interact with a device or system regardless of whether a touch screen is present.

Consider the technical problem of ambiguous touches. The familiar graphical user interface (GUI) “fat-finger” problem is an example: it is sometimes difficult to accurately click on a desired application GUI element (icon, control, link, etc.) on a touch device using a finger, due to the element's small size relative to the finger. The fat-finger problem persists despite advances in display technology. Touch screens have stayed relatively small for phones and tablets, even while the resolution becomes higher and higher, because portability is a high priority in these devices. With small screens, and ever higher resolutions permitting ever smaller GUI elements, precise activation of a particular GUI element on the screen with a finger becomes more difficult. Additional tools such as special pens are not always convenient.

Some operating systems currently try to determine a single finger click position from the finger coverage area, and fire a single event in response to a touch gesture. But this approach is prone to inaccuracy when the device screen size is small (e.g., in a smartphone) or whenever the button icon is small relative to the finger size. Some approaches try to solve this problem by creating a set of modern menus for use with fingers, making the button icons larger and putting more space in between them in these menus, so it will be easier to accurately activate the desired button. But retrofitting legacy applications under this approach requires recoding the applications to use the modern menus, which is not feasible given the vast number of existing applications and the fact they are produced by many different vendors.

Some vendors try to solve the fat finger problem by designing applications specifically to be suitable for control using a finger, but even a five-inch diagonal mobile device screen is too small to do much with an average human index finger in many familiar applications, because comfortably large controls take up too much screen space, leaving too little display area for other content. A five-inch screen, for example is approximately 136 mm by 70 mm. Assuming an average adult finger width of 11 mm, Microsoft Corporation has recommended using 9×9 mm targets for close, delete, and similar critical buttons, with other targets being at least 7×7 mm. Spacing targets 1 mm apart from one another, and assuming only two critical button icons, a row of icons across the top of the five-inch screen would then hold only eight icons. This is a very small number in comparison with icon rows in applications on a laptop or workstation, where a single row often contains two or three dozen icons.

Some embodiments described here provide an application GUI element with event handlers that are activated based on the touch surface area. The embodiment then displays the candidate GUI elements in a resolution menu for a user to select from and activate. Some embodiments dynamically adapt GUI elements (e.g., font size, button pixel dimensions, or button layout) in response to changes in the kind of input device used, e.g., a change from a stylus to a finger, from adult fingers to a child's fingers, from an elastic input source to an inelastic one, or a change from a device that provides pressure data to one that does not.

Some embodiments involve computing a finger click coverage area for application function activation, by calculating the finger click area or underlying touch points and comparing the result with the possible intended target(s). Then a particular application GUI element event handler can be activated and display the potential GUI elements enlarged in a resolution menu.

A related technical problem is how to determine a touch area and how to make use of the touch area to control a device or system. In personal computers, a familiar user-device interaction paradigm is based on the input devices such as mouse and keyboard providing precise input to a computational machine. Even now in a touch device era, the same paradigm has been applied. A single point of touch is derived from the finger touch surface area to interact with applications or the operating system (OS). Although the same paradigm works in the touch world, there are more natural ways that elastic objects such as fingers can interact with applications and the OS. Instead of determining a single point of contact from the touch surface area, an entire surface contact area can be used to interact with the device or system.

Some embodiments described herein compute a finger click coverage area for application function activation, such as interactive variable control. Some calculate the actual finger click area, and some utilize discrete points indicating the user's apparent intent.

With respect to multi-dimensional function activation, some familiar touch devices can capture movement of an input device (e.g., a finger) in two dimensions on the touch screen surface. Some embodiments described herein also determine movement in a Z-axis at an angle to the screen, thus enabling the operating system and/or application software to determine three-dimensional movement using the input device on a three-dimensional surface. Variables other than depth can also be controlled using actual pressure data or a simulated pressure derived from touch area size. For example, some embodiments use actual or simulated pressure to enable different writing or painting strokes. In particular, some use touch area as a proxy for inferred pressure to interactively control brush width when painting calligraphic characters such as Chinese characters or Japanese kanji characters.

Some embodiments described herein may be viewed in a broader context. For instance, concepts such as area, control, inputs, pressure, resizing, resolution, and touch may be relevant to a particular embodiment. However, it does not follow from the availability of a broad context that exclusive rights are being sought herein for abstract ideas; they are not. Rather, the present disclosure is focused on providing appropriately specific embodiments whose technical effects fully or partially solve particular technical problems. Other media, systems, and methods involving area, control, inputs, pressure, resizing, resolution, or touch are outside the present scope. Accordingly, vagueness, mere abstractness, lack of technical character, and accompanying proof problems are also avoided under a proper understanding of the present disclosure.

The technical character of embodiments described herein will be readily apparent to one of ordinary skill in the relevant art(s). The technical character of embodiments will also be apparent in several ways to a wide range of attentive readers, as noted below.

First, some embodiments address technical problems such as the fat-finger problem, the lack of actual pressure data from touch screens that use capacitive display technology, the infeasibility of retrofitting thousands of existing applications with a different GUI, and how to take advantage in a GUI of changes in which input source is used.

Second, some embodiments include technical components such as computing hardware which interacts with software in a manner beyond the typical interactions within a general purpose computer. For example, in addition to normal interaction such as memory allocation in general, memory reads and write in general, instruction execution in general, and some sort of I/O, some embodiments described herein provide functions which monotonically relate touch surface area to pressure or another touch magnitude. Some include mechanisms for detecting input source changes. Some include two or more input-source-dependent GUIs. Some include ambiguous touch resolution menus.

Third, technical effects provided by some embodiments include changes in font size, changes in GUI layout, changes in GUI element display size, presentation of a resolution menu, or control of an interactive variable, e.g., ink flow, rendered object movement, or line width.

Fourth, some embodiments modify technical functionality of GUIs by resolution menus. Some modify technical functionality of GUIs based on input source changes, and some modify technical functionality of GUIs based on touch area size.

Fifth, technical advantages of some embodiments include improved usability and lower error rates in user interaction via GUIs, through resolution of ambiguous touches. Some embodiments advantageously reduce hardware requirements for interactive control of variables, because capacitive displays (or similar touch-only-no-pressure-data displays) can be functionally extended to provide simulated pressure data, thus avoiding the need for displays that sense both touch and pressure. As an aside, the difference between touch and pressure is that touch is binary—the screen registers touches only as present/absent—whereas pressure has degrees, e.g., low/medium/high. Some embodiments detect a change from a pointing device (input source) that requires larger buttons, such as a finger, to a pointing device that does not, such as a trackball, trackpad, joystick, or mouse. Such embodiments can then adapt the GUI to use smaller elements, thus advantageously reducing the amount of screen space required by these GUI elements.

In short, embodiments apply concrete technical capabilities such as resolution menus, area-to-pressure functions, and input source identifier change detection and adaptions. These technical capabilities are applied to obtain particular technical effects such as ambiguous touch resolution to obtain a GUI element selection, a GUI size and layout that is tailored to the input device being used, and intuitive control of user-visible interactive variables. These technical capabilities are directed to specific technical problems such as ambiguous touch gestures, space limitations on small screens, and lack of pressure data, thereby providing concrete and useful technical solutions.

Reference will now be made to exemplary embodiments such as those illustrated in the drawings, and specific language will be used herein to describe the same. But alterations and further modifications of the features illustrated herein, and additional technical applications of the abstract principles illustrated by particular embodiments herein, which would occur to one skilled in the relevant art(s) and having possession of this disclosure, should be considered within the scope of the claims.

The meaning of terms is clarified in this disclosure, so the claims should be read with careful attention to these clarifications. Specific examples are given, but those of skill in the relevant art(s) will understand that other examples may also fall within the meaning of the terms used, and within the scope of one or more claims. Terms do not necessarily have the same meaning here that they have in general usage (particularly in non-technical usage), or in the usage of a particular industry, or in a particular dictionary or set of dictionaries. Reference numerals may be used with various phrasings, to help show the breadth of a term. Omission of a reference numeral from a given piece of text does not necessarily mean that the content of a Figure is not being discussed by the text. The inventors assert and exercise their right to their own lexicography. Quoted terms are defined explicitly, but quotation marks are not used when a term is defined implicitly. Terms may be defined, either explicitly or implicitly, here in the Detailed Description and/or elsewhere in the application file.

As used herein, a “computer system” may include, for example, one or more servers, motherboards, processing nodes, personal computers (portable or not), personal digital assistants, smartphones, cell or mobile phones, other mobile devices having at least a processor and a memory, and/or other device(s) providing one or more processors controlled at least in part by instructions. The instructions may be in the form of firmware or other software in memory and/or specialized circuitry. In particular, although it may occur that many embodiments run on workstation or laptop computers, other embodiments may run on other computing devices, and any one or more such devices may be part of a given embodiment.

A “multithreaded” computer system is a computer system which supports multiple execution threads. The term “thread” should be understood to include any code capable of or subject to scheduling (and possibly to synchronization), and may also be known by another name, such as “task,” “process,” or “coroutine,” for example. The threads may run in parallel, in sequence, or in a combination of parallel execution (e.g., multiprocessing) and sequential execution (e.g., time-sliced). Multithreaded environments have been designed in various configurations. Execution threads may run in parallel, or threads may be organized for parallel execution but actually take turns executing in sequence. Multithreading may be implemented, for example, by running different threads on different cores in a multiprocessing environment, by time-slicing different threads on a single processor core, or by some combination of time-sliced and multi-processor threading. Thread context switches may be initiated, for example, by a kernel's thread scheduler, by user-space signals, or by a combination of user-space and kernel operations. Threads may take turns operating on shared data, or each thread may operate on its own data, for example.

A “logical processor” or “processor” is a single independent hardware thread-processing unit, such as a core in a simultaneous multithreading implementation. As another example, a hyperthreaded quad core chip running two threads per core has eight logical processors. A logical processor includes hardware. The term “logical” is used to prevent a mistaken conclusion that a given chip has at most one processor; “logical processor” and “processor” are used interchangeably herein. Processors may be general purpose, or they may be tailored for specific uses such as graphics processing, signal processing, floating-point arithmetic processing, encryption, I/O processing, and so on.

A “multiprocessor” computer system is a computer system which has multiple logical processors. Multiprocessor environments occur in various configurations. In a given configuration, all of the processors may be functionally equal, whereas in another configuration some processors may differ from other processors by virtue of having different hardware capabilities, different software assignments, or both. Depending on the configuration, processors may be tightly coupled to each other on a single bus, or they may be loosely coupled. In some configurations the processors share a central memory, in some they each have their own local memory, and in some configurations both shared and local memories are present.

“Kernels” include operating systems, hypervisors, virtual machines, BIOS code, and similar hardware interface software.

“Code” means processor instructions, data (which includes constants, variables, and data structures), or both instructions and data.

“Program” is used broadly herein, to include applications, kernels, drivers, interrupt handlers, libraries, and other code written by programmers (who are also referred to as developers).

As used herein, “include” allows additional elements (i.e., includes means comprises) unless otherwise stated. “Consists of” means consists essentially of, or consists entirely of. X consists essentially of Y when the non-Y part of X, if any, can be freely altered, removed, and/or added without altering the functionality of claimed embodiments so far as a claim in question is concerned.

“Process” is sometimes used herein as a term of the computing science arts, and in that technical sense encompasses resource users, namely, coroutines, threads, tasks, interrupt handlers, application processes, kernel processes, procedures, and object methods, for example. “Process” is also used herein as a patent law term of art, e.g., in describing a process claim as opposed to a system claim or an article of manufacture (configured storage medium) claim. Similarly, “method” is used herein at times as a technical term in the computing science arts (a kind of “routine”) and also as a patent law term of art (a “process”). Those of skill will understand which meaning is intended in a particular instance, and will also understand that a given claimed process or method (in the patent law sense) may sometimes be implemented using one or more processes or methods (in the computing science sense).

“Automatically” means by use of automation (e.g., general purpose computing hardware configured by software for specific operations and technical effects discussed herein), as opposed to without automation. In particular, steps performed “automatically” are not performed by hand on paper or in a person's mind, although they may be initiated by a human person or guided interactively by a human person. Automatic steps are performed with a machine in order to obtain one or more technical effects that would not be realized without the technical interactions thus provided.

One of skill understands that technical effects are the presumptive purpose of a technical embodiment. The mere fact that calculation is involved in an embodiment, for example, and that some calculations can also be performed without technical components (e.g., by paper and pencil, or even as mental steps) does not remove the presence of the technical effects or alter the concrete and technical nature of the embodiment.

“Computationally” likewise means a computing device (processor plus memory, at least) is being used, and excludes obtaining a result by mere human thought or mere human action alone. For example, doing arithmetic with a paper and pencil is not doing arithmetic computationally as understood herein.

Computational results are faster, broader, deeper, more accurate, more consistent, more comprehensive, and/or otherwise provide technical effects that are beyond the scope of human performance alone. “Computational steps” are steps performed computationally. Neither “automatically” nor “computationally” necessarily means “immediately”. “Computationally” and “automatically” are used interchangeably herein.

“Proactively” means without a direct request from a user. Indeed, a user may not even realize that a proactive step by an embodiment was possible until a result of the step has been presented to the user. Except as otherwise stated, any computational and/or automatic step described herein may also be done proactively.

Some terminology used by the inventors has changed over time. For example, “fuzzy click” handling is now referred to as “ambiguous touch resolution, and a “finger click area” is now referred to herein as the “touch area” or “contact area” because screen contact is not limited to fingers (e.g., thumbs are also covered) and because screen contact is not limited to clicking (other kinds of touch such as sliding, dragging, circling, and multi-touch gestures are also covered). Likewise, a “context menu” is now referred to as the “resolution menu” to help avoid confusion. Also, the word “digit” is defined it to mean a finger or a thumb.

Throughout this document, use of the optional plural “(5)”, “(es)”, or “(ies)” means that one or more of the indicated feature is present. For example, “processor(s)” means “one or more processors” or equivalently “at least one processor”.

Throughout this document, unless expressly stated otherwise any reference to a step in a process presumes that the step may be performed directly by a party of interest and/or performed indirectly by the party through intervening mechanisms and/or intervening entities, and still lie within the scope of the step. That is, direct performance of the step by the party of interest is not required unless direct performance is an expressly stated requirement. For example, a step involving action by a party of interest such as activating, adapting, affiliating, applying, arranging, assigning, associating, calculating, calibrating, changing, checking, computing, controlling, converting, defining, detecting, determining, disabling, displaying, enabling, furnishing, identifying, linking, making, obtaining, performing, positioning, providing, putting, querying, receiving, registering, relating, resolving, satisfying, selecting, sending, specifying, supplying, using, utilizing, zooming, (and activates, activated, adapts, adapted, etc.) with regard to a destination or other subject may involve intervening action such as forwarding, copying, uploading, downloading, encoding, decoding, compressing, decompressing, encrypting, decrypting, authenticating, invoking, and so on by some other party, yet still be understood as being performed directly by the party of interest.

Whenever reference is made to data or instructions, it is understood that these items configure a computer-readable memory and/or computer-readable storage medium, thereby transforming it to a particular article, as opposed to simply existing on paper, in a person's mind, or as a mere signal being propagated on a wire, for example. Unless expressly stated otherwise in a claim, a claim does not cover a signal per se. For the purposes of patent protection in the United States, a memory or other computer-readable storage medium is not a propagating signal or a carrier wave outside the scope of patentable subject matter under United States Patent and Trademark Office (USPTO) interpretation of the In re Nuijten case.

Moreover, notwithstanding anything apparently to the contrary elsewhere herein, a clear distinction is to be understood between (a) computer readable storage media and computer readable memory, on the one hand, and (b) transmission media, also referred to as signal media, on the other hand. A transmission medium is a propagating signal or a carrier wave computer readable medium. By contrast, computer readable storage media and computer readable memory are not propagating signal or carrier wave computer readable media. Unless expressly stated otherwise in a claim, “computer readable medium” means a computer readable storage medium, not a propagating signal per se.

Operating Environments

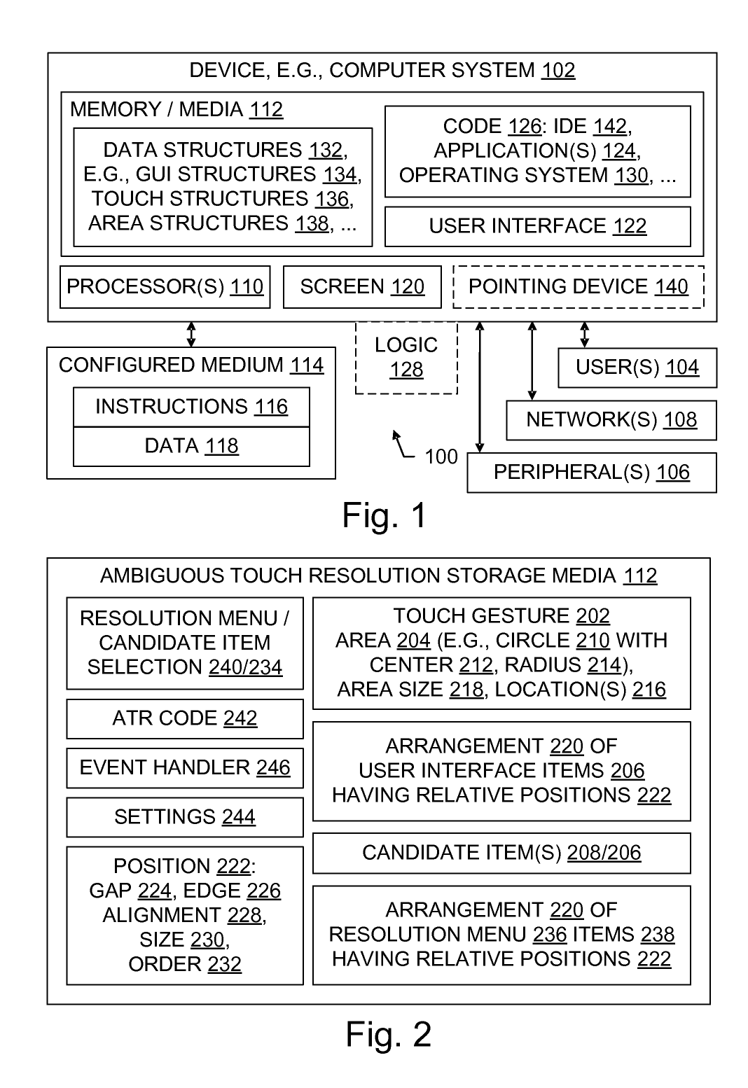

With reference to FIG. 1, an operating environment 100 for an embodiment may include a computer system 102. An individual device 102 is an example of a system 102. The computer system 102 may be a multiprocessor computer system, or not. An operating environment may include one or more machines in a given computer system, which may be clustered, client-server networked, and/or peer-to-peer networked. An individual machine is a computer system, and a group of cooperating machines is also a computer system. A given computer system 102 may be configured for end-users, e.g., with applications, for administrators, as a server, as a distributed processing node, and/or in other ways.

Human users 104 may interact with the computer system 102 by using display screens 120, keyboards and other peripherals 106, via typed text, touch, voice, movement, computer vision, gestures, and/or other forms of I/O. A user interface 122 may support interaction between an embodiment and one or more human users. A user interface 122 may include a command line interface, a graphical user interface (GUI), natural user interface (NUI), voice command interface, and/or other interface presentations. A user interface 122 may be generated on a local desktop computer, or on a smart phone, for example, or it may be generated from a web server and sent to a client. The user interface 122 may be generated as part of a service and it may be integrated with other services, such as social networking services. A given operating environment 100 includes devices and infrastructure which support these different user interface generation options and uses.

Natural user interface (NUI) operation may use speech recognition, touch and stylus recognition, touch gesture recognition on the screen 120 and recognition of other gestures adjacent to the screen 120, air gestures, head and eye tracking, voice and speech, vision, touch, combined gestures, and/or machine intelligence, for example. Some examples of NUI technologies in peripherals 106 include touch sensitive displays 120, voice and speech recognition, intention and goal understanding, motion gesture detection using depth cameras (such as stereoscopic camera systems, infrared camera systems, RGB camera systems and combinations of these), motion gesture detection using accelerometers/gyroscopes, facial recognition, 3D displays, head, eye, and gaze tracking, immersive augmented reality and virtual reality systems, all of which provide a more natural interface, as well as technologies for sensing brain activity using electric field sensing electrodes (electroencephalograph and related tools).

Screen(s) 120 in a device or system 102 may include touch screens (single-touch or multi-touch), non-touch screens, screens that register pressure, and/or one or more screens that do not register pressure. Moreover, screen 120 may utilize capacitive sensors, resistive sensors, surface acoustic wave components, infrared detectors, optical imaging touchscreen technology, acoustic pulse recognition, liquid crystal display, cathodoluminescence, electroluminescence, photoluminescence, and/or other display technologies. Pressure registering screens may use pressure-sensitive coatings, quantum tunneling, and/or other technologies.

One of skill will appreciate that the foregoing aspects and other aspects presented herein under “Operating Environments” may also form part of a given embodiment. This document's headings are not intended to provide a strict classification of features into embodiment and non-embodiment feature classes. Similarly, reference numerals are not intended to provide a strict or overly simplistic classification of characteristics. For example, although all screens are referred to using reference numeral 120, some of those screens 120 are touch screens and some are not, and some of those screens 120 have hardware that registers pressure and some do not. All screens 120, however, do display at least a portion of user interface 122.

As another example, a game application 124 may be resident on a Microsoft XBOX Live® server (mark of Microsoft Corporation). The game may be purchased from a console device 102 and it may be executed in whole or in part on the server of a computer system 102 comprising the server and the console. The game may also be executed on the console, or on both the server and the console. Multiple users 104 may interact with the game using standard controllers, air gestures, voice, or using a companion device such as a smartphone or a tablet. A given operating environment includes devices and infrastructure which support these different use scenarios.

System administrators, developers, engineers, and end-users are each a particular type of user 104. Automated agents, scripts, playback software, and the like acting on behalf of one or more people may also be users 104. Storage devices and/or networking devices may be considered peripheral equipment in some embodiments. Other computer systems not shown in FIG. 1 may interact in technological ways with the computer system 102 or with another system embodiment using one or more connections to a network 108 via network interface equipment, for example.

The computer system 102 includes at least one logical processor 110. The computer system 102, like other suitable systems, also includes one or more computer-readable storage media 112. Media 112 may be of different physical types. The media 112 may be volatile memory, non-volatile memory, fixed in place media, removable media, magnetic media, optical media, solid-state media, and/or of other types of physical durable storage media (as opposed to merely a propagated signal). In particular, a configured medium 114 such as a portable (i.e., external) hard drive, CD, DVD, memory stick, or other removable non-volatile memory medium may become functionally a technological part of the computer system when inserted or otherwise installed, making its content accessible for interaction with and use by processor 110. The removable configured medium 114 is an example of a computer-readable storage medium 112. Some other examples of computer-readable storage media 112 include built-in RAM, ROM, hard disks, and other memory storage devices which are not readily removable by users 104. For compliance with current United States patent requirements, neither a computer-readable medium nor a computer-readable storage medium nor a computer-readable memory is a signal per se.

The medium 114 is configured with instructions 116 that are executable by a processor 110; “executable” is used in a broad sense herein to include machine code, interpretable code, bytecode, and/or code that runs on a virtual machine, for example. The medium 114 is also configured with data 118 which is created, modified, referenced, and/or otherwise used for technical effect by execution of the instructions 116. The instructions 116 and the data 118 configure the memory or other storage medium 114 in which they reside; when that memory or other computer readable storage medium is a functional part of a given computer system, the instructions 116 and data 118 also configure that computer system. In some embodiments, a portion of the data 118 is representative of real-world items such as product characteristics, inventories, physical measurements, settings, images, readings, targets, volumes, and so forth. Such data is also transformed by backup, restore, commits, aborts, reformatting, and/or other technical operations.

Although an embodiment may be described as being implemented as software instructions 116, 126 executed by one or more processors 110 in a computing device 102 (e.g., general purpose computer, cell phone, or gaming console), such description is not meant to exhaust all possible embodiments. One of skill will understand that the same or similar functionality can also often be implemented, in whole or in part, directly in hardware logic, to provide the same or similar technical effects. Alternatively, or in addition to software implementation, the technical functionality described herein can be performed, at least in part, by one or more hardware logic 128 components. For example, and without excluding other implementations, an embodiment may include hardware logic 128 components such as Field-Programmable Gate Arrays (FPGAs), Application-Specific Integrated Circuits (ASICs), Application-Specific Standard Products (ASSPs), System-on-a-Chip components (SOCs), Complex Programmable Logic Devices (CPLDs), and similar components. Components of an embodiment may be grouped into interacting functional modules based on their inputs, outputs, and/or their technical effects, for example.

In the illustrated environments 100, one or more applications 124 have code 126 such as user interface code 122 and associated operating system 130 code. Software code 126 includes data structures 132 such as buttons, icons, windows, sliders and other GUI structures 134, touch location representations and other touch structures 136, and/or touch contact area structures 138, for example.

The application 124, operating system 130, data structures 132, and other items shown in the Figures and/or discussed in the text, may each reside partially or entirely within one or more hardware media 112. In thus residing, they configure those media for technical effects which go beyond the “normal” (i.e., least common denominator) interactions inherent in all hardware—software cooperative operation.

In addition to processors 110 (CPUs, ALUs, FPUs, and/or GPUs), memory/storage media 112, display(s), and battery(ies), an operating environment may also include other hardware, such as pointing devices 140, buses, power supplies, wired and wireless network interface cards, and accelerators, for instance, whose respective operations are described herein to the extent not already apparent to one of skill. CPUs are central processing units, ALUs are arithmetic and logic units, FPUs are floating point processing units, and GPUs are graphical processing units.

A given operating environment 100 may include an Integrated Development Environment (IDE) 142 which provides a developer with a set of coordinated software development tools such as compilers, source code editors, profilers, debuggers, and so on. In particular, some of the suitable operating environments for some embodiments include or help create a Microsoft® Visual Studio® development environment (marks of Microsoft Corporation) configured to support program development. Some suitable operating environments include Java® environments (mark of Oracle America, Inc.), and some include environments which utilize languages such as C++ or C# (“C-Sharp”), but teachings herein are applicable with a wide variety of programming languages, programming models, and programs, as well as with technical endeavors outside the field of software development per se.

One or more items are shown in outline form in FIG. 1 to emphasize that they are not necessarily part of the illustrated operating environment, but may interoperate with items in the operating environment as discussed herein. It does not follow that items not in outline form are necessarily required, in any Figure or any embodiment. FIG. 1 is provided for convenience; inclusion of an item in FIG. 1 does not imply that the item, or the describe use of the item, was known prior to the current innovations.

Systems

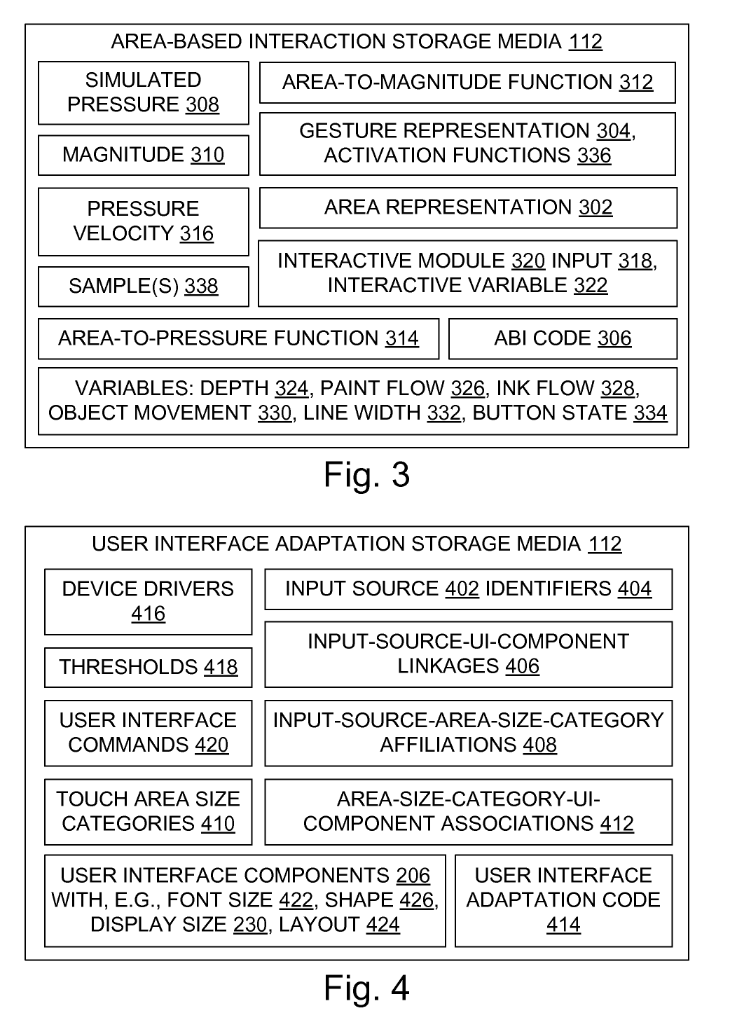

FIGS. 2 through 4 each illustrate aspects of architectures which are suitable for use with some embodiments. FIG. 2 focuses on embodiments which have ambiguous touch resolution capabilities, FIG. 3 focuses on embodiments which have touch-area-based interaction capabilities, and FIG. 4 focuses on embodiments which have input-source-specific user interface adaptation capabilities. However, the separation of components into Figures is for discussion convenience only, because a given embodiment may include aspects illustrated in two or more Figures.

With reference to FIGS. 1 through 4, some embodiments provide a computer system 102 with a logical processor 110 and a memory medium 112 configured by circuitry, firmware, and/or software to provide technical effects such as ambiguous touch resolution, touch-area-based interaction, and/or input-source-specific user interface adaptation. These effects can be directed at related technical problems noted herein, by extending functionality as described herein.

As illustrated in FIG. 2, some embodiments help resolve ambiguous touch gestures 202, which occur for example when an area 204 of contact between a pointing device 140 (e.g., a finger unless ruled out) and a touch screen 120 does not clearly indicate a unique GUI item 206 of a user interface 122. The contact area 204 may overlap two or more candidate items 208, for example, so it is unclear which item the user meant to select. One such ambiguous situation is illustrated in FIGS. 10 through 12.

As discussed further below, the contact area 204 may be defined in various ways, e.g., as a set of one or more locations 216 (X-Y coordinate points), a bitmap, a polygon, or a circle 210 having a center 212 and a radius 214. The contact area 204 can be treated as if it were only a point (e.g., a single location 216), or it can have both a location and an associated area size 218.

In some embodiments, user interface 122 items 206 are laid out on a screen 120 in an arrangement 220 in which the items 206 have positions 222 relative to one another. The positions 222 can be defined in a given embodiment using characteristics such as gaps 224 between edges 226 of displayed items, alignment 228 of item edges 226, absolute (e.g., pixel dimensions) and/or relative size 230 of item(s) 206, and order 232 of items 206 (in left-to-right, top-to-bottom, front-to-back, or any other recognized direction).

In some embodiments, resolution of an ambiguous touch gesture 202 into a selection 234 of a particular user interface item 206 is accomplished using a resolution menu 236. A resolution menu includes resolution menu items 238 in an arrangement 220, which differs however from the arrangement 220 of candidate items 208, in order to facilitate resolution of the ambiguity. Examples are discussed below, and one example of a resolution menu is illustrated in FIG. 13.

In some embodiments, a selection 240 of a resolution menu item is converted into a selection 234 of a candidate item 208 by Ambiguous Touch Resolution (ATR) code 242. The ATR code may implicate settings 244, such as a preferred resolution which will be applied unless the user overrides it, e.g., one setting prefers other choices over delete if delete is one of the candidates 208. The ATR code 242 in some embodiments includes an event handler 246 which displays a resolution menu 236, obtains a resolution menu item selection 240, converts that selection 240 to a candidate item selection 234, and then sends the application 124 the candidate item selection 234. ATR code 242 thus provides a mechanism to upgrade existing applications with an ambiguous touch resolution capability.

As illustrated in FIG. 3, some embodiments provide area-based interaction. In addition to a touch gesture 202 having a location 216, the gesture has an area representation 302. The area representation 302 may be implemented using familiar touch structures 136 if they include the necessary fields, or if not then by supplementing location-only touch structures 136 with area structures 138. The area representation 302 may be implemented using a set of one or more locations 216 (X-Y coordinate points), a bitmap, a polygon, or a circle 210 having a center 212 and a radius 214, or a set of discrete points (some or all of which lie within the physical contact area; points outside the physical contact area may be interpolated). A touch gesture 202 has a gesture representation 304, which includes a data structure 132 containing information such as touch location(s) 216, touch begin time/end time/duration, touch area 204, and/or nature of touch. Some examples of the nature of touch include single-digit vs. multi-digit touch, trajectory of touch, touch pressure, input source of touch, and touch velocity.

In some embodiments, Area-Based Interaction (ABI) code 306 interprets touch areas as simulated pressures 308 or other magnitudes 310 which are not an area size 218 per se. Some of the many possible examples of magnitudes 310 include pressure, speed, depth, width, intensity, and repetition rate. Some ABI code 306 embodiments include an area-to-magnitude function 312, such as an area-to-pressure function 314, which computationally relates contact area size to a magnitude. The relationship function 312, 314 may be continuous or it may be a discontinuous function such as a stair-step function, and it may be linear, polynomial, logarithmic, a section of a trigonometric curve, or another monotonic function, for example. Touch area 204 samples 338 may be used to calibrate the relationship function 312, 314.

In some embodiments, a pressure velocity 316 can be defined as the change in pressure over time. Pressure velocity can be defined, for example, when an area-to-pressure function 314 is used, or in other situations in which an actual or simulated pressure value is available from a sequence of touches or touch sample points in time.

Pressure 308, other touch magnitudes 310, and pressure velocity 316 may be used individually or in combination as inputs 318 to an interactive module 320 in order to control an interactive variable 322. Some of the many examples of interactive variables 322 are depth 324, paint flow 326, ink flow 328, object movement 330, line width 332, and button or other GUI item state 334. More generally, user interface components 206 give users control over applications 124 by offering various activation functions 336, namely, functionality that is activated by a user via the user interface 122.

As illustrated in FIG. 4, some embodiments provide user interface adaptation to different input sources 402. Input sources 402 include, for example, pointing devices 140, and keyboards and other peripherals 106. “Pointing device” is normally defined broadly herein, e.g., to include not only mechanical devices but also fingers and thumbs (digits). However, at other times “pointing device” is expressly narrowed to a more limited definition, e.g., by ruling out digits. A given input source 402 has a name, handle, serial number, or other identifier 404. In some embodiments, linkages 406 correlate input source identifiers 404 with user interface components 206 provided 2436 in a system. In some embodiments, affiliations 408 correlate input source identifiers 404 with touch area size categories 410. In some embodiments, associations 412 correlate touch area size categories 410 with the provided 2436 user interface components 206. The linkages 406, affiliations 408, and associations 412 may be implemented as data structures 132, such as a linked list of pairs, a table of pairs, a hash table, or other structures.

In some embodiments, User Interface Adaptation (UIA) code 414 detects changes in input source identifiers 404, e.g., by checking with device drivers 416 or by noting that touch area sizes 218 have crossed a threshold 418. UIA code 414 may also receive explicit notice from a user command 420 that a different input source is now being used, or shortly will be used. In response, the UIA code 414 adapts the user interface 122 to better suit the current or upcoming input source. For example, the UIA code 414 may change user interface item font size 422 (e.g., by swapping an item with a given activation functionality and font size for an item 206 with the same activation functionality 336 but a different font size), display size 230, display shape 426 (e.g., rectangular buttons with sharp corners, or buttons with rounded corners, or buttons which are oval/circular), and/or layout 424 (layout includes visibility and position 222).

In some embodiments peripherals 106 such as human user I/O devices (screen, keyboard, mouse, tablet, microphone, speaker, motion sensor, etc.) will be present in operable communication with one or more processors 110 and memory. However, an embodiment may also be deeply embedded in a technical system such as a simulated user environment, such that no human user 104 interacts directly with the embodiment. Software processes may be users 104.

In some embodiments, the system includes multiple computers connected by a network. Networking interface equipment can provide access to networks 108, using components such as a packet-switched network interface card, a wireless transceiver, or a telephone network interface, for example, which may be present in a given computer system. However, an embodiment may also communicate technical data and/or technical instructions through direct memory access, removable nonvolatile media, or other information storage-retrieval and/or transmission approaches, or an embodiment in a computer system may operate without communicating with other computer systems.

Some embodiments operate in a “cloud” computing environment and/or a “cloud” storage environment in which computing services are not owned but are provided on demand. For example, a user interface 122 may be displayed on one device or system 102 in a networked cloud, and ABI code 306 or UIA code 414 may be stored on yet other devices within the cloud until invoked.

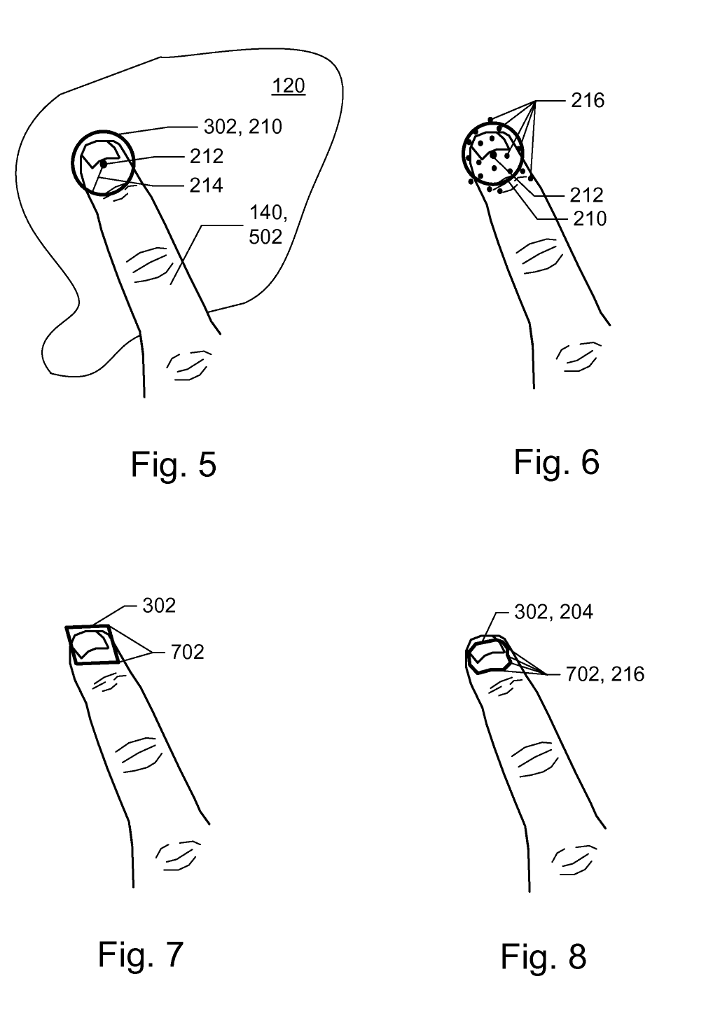

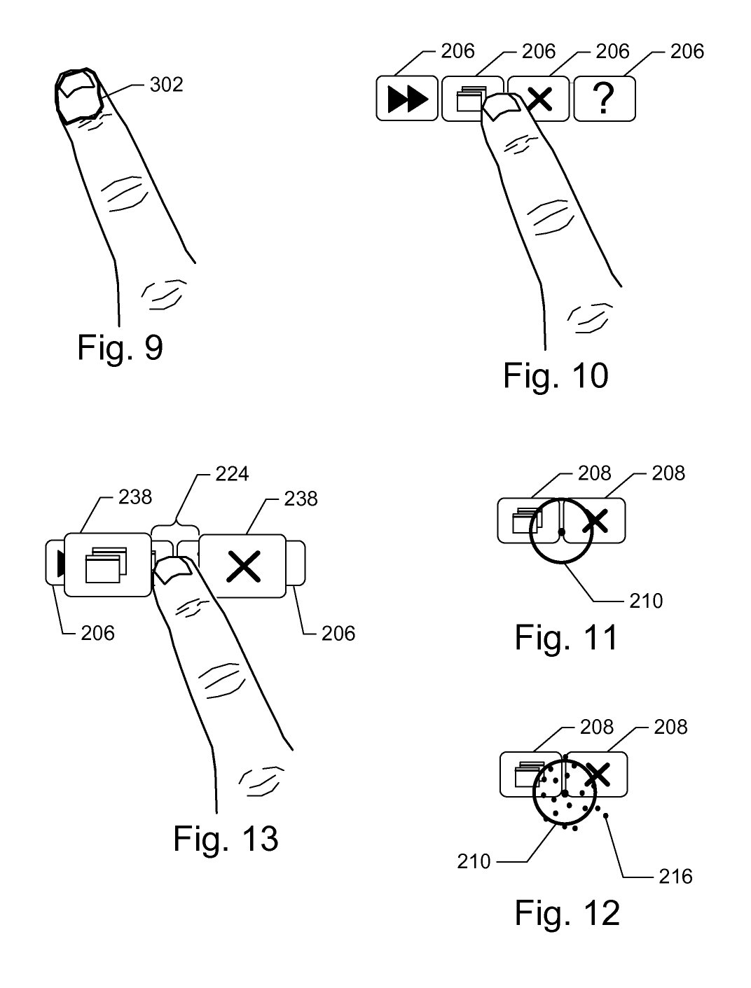

Several examples of touch area representations 302 are illustrated in the Figures. FIG. 5 shows a circular representation 302 of a touch area of a user's finger 502. Figure shows a circular representation 302 calculated from a multiple location 216 point representation 302 of a touch contact area. FIG. 7 shows a quadrilateral representation 302. FIG. 8 shows a first example of a polygonal representation 302 of a touch contact area in which the contact area 204 used in the software 126 lies within the physical contact area; FIG. 9 shows a second example of a polygonal representation 302 in which some of the contact area 204 lies outside the physical contact area. One of skill can readily convert between a bitmap representation and a polygonal representation.

Those of skill will acknowledge that when a finger or other pointing device 140 touches a screen 120, distinctions may be made between the actual physical contact region, the sensors within the screen that sense the contact, the contact data that is provided by the screen device driver, and the contact information that is used within an operating system or application. For present purposes, however, one assumes that the screen is sensitive enough that the sensors within the screen that sense the contact closely approximate the actual physical contact region. Embodiments that operate on a contact area (whether obtained as an area per se or from a collection of individual points) assume that the contact area information used within an operating system or application is available from the screen directly or via a device driver.

For convenience, data structures and their illustrations are discussed somewhat interchangeably, because one of skill understands what is meant. For example, FIG. 7 illustrates a quadrilateral contact area representation 302 in memory 112. The physical contact area and the raw data from the screen sensors were most likely not a quadrilateral, but they can be processed to provide a quadrilateral representation 302 corresponding to a quadrilateral area 204. The quadrilateral representation 302 would be implemented in a particular programming language using particular data structures such as a record or struct or object or class or linked list having four vertex points 702, each of which includes an X value and a Y value, thus specifying a location 216. One of skill would understand that instead of giving four absolute points, a quadrilateral contact area representation 302 could also be implemented using a single absolute start point followed by three relative offsets that identify the other three vertex points 702. Other implementations within the grasp of one of skill are likewise included when reference is made herein to a quadrilateral contact area representation 302. Similar considerations apply to other area representations 302.

FIG. 10 shows a user's finger making an ambiguous touch gesture. The finger touches two user interface components 206, so it is not immediately clear to the application behind those components which component the user wishes to select. FIG. 11 further illustrates the ambiguity, using a circle 210 representation 302, but touches in systems 102 that use a different area representation 302 may likewise be ambiguous. In this example, two of the four components 206 shown in FIG. 10 overlap with the touch area circle 210, so those two components 206 are treated by ATR code 242 as candidate items 208, meaning that they are the best candidates for the selection the user intended to make. FIG. 12 illustrates the point that touches may be ambiguous even when different representations 302 are used; in FIG. 12 the representation 302 is a circle but is derived from multiple touch points 216 rather than being derived from a single center point 212.

FIG. 13 shows two resolution menu items 238 displayed by ATR code 242 to resolve the ambiguity shown in FIG. 10. The resolution menu items 238 in this example include larger display versions of the underlying candidate items 208. These resolution menu items 238 are also positioned differently than their counterpart items 208, as indicated for example by the relatively larger gap 224 between them in comparison to the gap between their counterpart items 208.

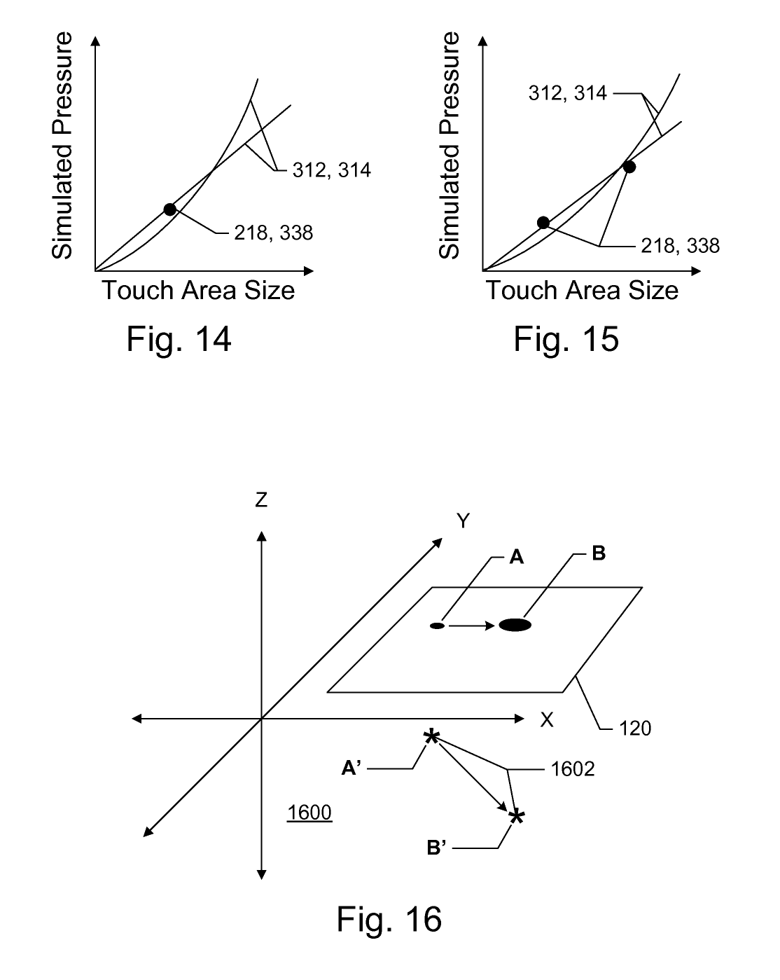

FIGS. 14 and 15 illustrate the step of calibrating an area-to-magnitude function 312 or an area-to-pressure function 314 using one sample touch area size (FIG. 14) or using two sample touch area sizes 338 (FIG. 15). Sample touch area sizes 338 are touch area sizes 218 used for at least the purpose of calibrating a function 312 or 314. The sample touch area sizes 338 may be used solely for calibration, or they may also be used for control of an interactive variable 322. Although the graphs in these Figures are labeled to show calibration curves for simulated pressure 308 as a function 314 of touch area size, calibration may likewise be performed to determine other magnitudes 310 as functions 312 of touch area size. Likewise, more than two sample touch area sizes 338 may be used for calibrating a function 312 or 314, even though the examples illustrated in these Figures use one sample point or two sample points.

FIG. 16 illustrates control of an interactive variable 322 during an area-based interaction. During an extended touch gesture 202, which may also be processed as a sequence of constituent touch gestures 202, a contact area 204 moves from position A on the two-dimensional screen 120 to position B on the screen 120. During this movement, the contact area size 218 increases. ABI code 306 relates contact area size 218 to the magnitude 310 variable depth 324, with increased area size 218 monotonically corresponding to increased depth 324. Thus, a focus point or a rendered object or a camera position or some other aspect 1602 of the user interface 122 which is controlled 2420 by the depth variable 322 moves from a position A′ in a three-dimensional space 1600 to a relatively deeper position B′ in the three-dimensional space. In some other embodiments, the relationship is inverse, such that increased area size 218 monotonically corresponds to decreased depth 324. In some embodiments, a variable 322 other than depth 324 is likewise controlled during an area-based interaction.

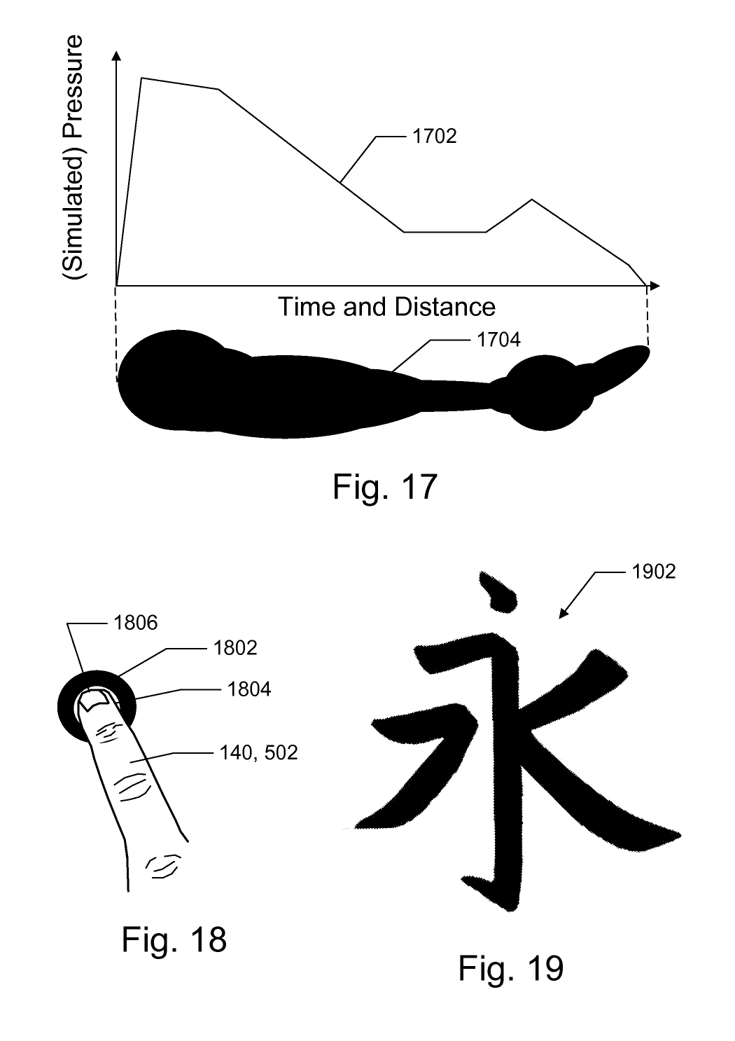

FIG. 17 illustrates control of an interactive variable 322 line width 332 through an actual or simulated pressure variable 322. As shown, changes in an actual or simulated pressure 1702 cause corresponding changes in the width 332 of a line segment 1704. The relationship between pressure 1702 and width 332 (or any other controlled variable 322) need not be linear and need not be continuous; variable 322 control relationships may be logarithmic or exponential, defined by splines, defined by a section of a trigonometric function, randomized, and/or step functions, for example. Any computable relationship can be used.

FIG. 18 illustrates control of an interactive variable 322 ink flow 328. Note that the screen area covered by electronic ink 1802 is larger than the contact area 1804, 204. This can occur, for example, when ink continues to flow onto the screen 120 out of a virtual pen 1806 until the pen (controlled by a finger 502 pointing device 140 in this example) is removed from the screen's surface.

FIG. 19 shows a calligraphic character 1902 which has lines of varying width 332. This particular character, which represents the concept of eternity, is often used in calligraphic lessons, but many Chinese characters and many Japanese kanji characters (often derived from Chinese origins) will be perceived as most aesthetically pleasing—and most authentic—when drawn with a real brush or virtual brush that permits the user to vary line width 332 during a given stroke.

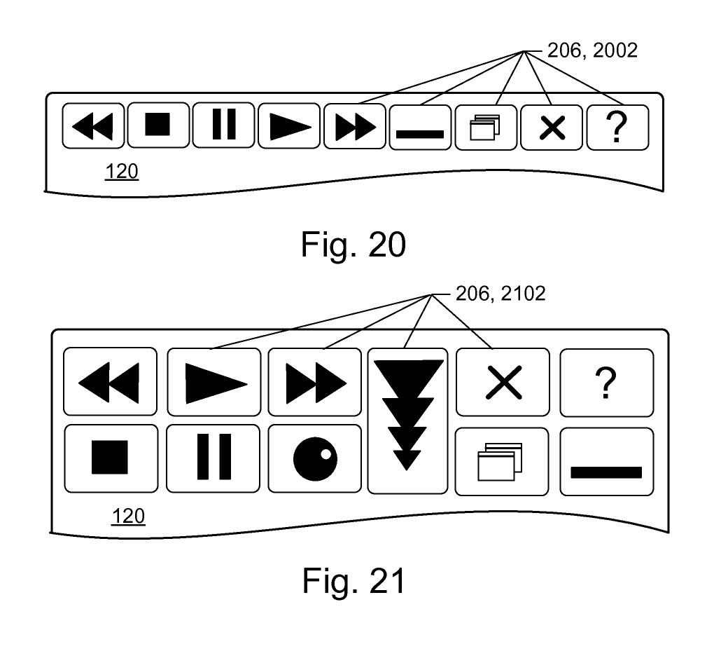

FIGS. 20 and 21 illustrate adaptation of a user interface 122 by UIA code 414 in response to a change in input sources. In this example, FIG. 20 shows a portion of the user interface 122 in an arrangement 220 adapted for a relatively fine-grained pointing device 140, e.g., a mouse, trackpad, trackball, joystick, stylus, or pen. User interface activation functions are available through a first set 2002 of components 206, which are relatively small, e.g., 4 mm by 6 mm, or 3 mm by 5 mm, to name two of the many possible sizes 230. In the particular example shown, the activation functions 336 offered are, from left to right: fast rewind, stop, pause, play, fast forward, minimize, search folders, exit, and get help. Other embodiments could offer different activation functions and/or offer activation functions using different symbols on icons.

FIG. 21 continues the example of FIG. 20 by showing a portion of the same user interface 122 in a different arrangement 220, namely, an arrangement that has been adapted by UIA code 414 for a relatively coarse-grained pointing device 140, e.g., a finger or thumb, a laser pointer held several inches (or even several feet) from the screen 120, or a computer-vision system which uses a camera and computer vision analysis to detect hand gestures or body gestures as they are made by a user 104. User interface activation functions are now available through a second set 2102 of components 206, which are relatively large compared with the first set 2002 of components 206, e.g., 6 mm by 9 mm, or 7 mm by 10 mm, to name two of the many possible sizes 230. The drawing Figures are not necessarily to scale. In the particular example shown, the activation functions 336 now offered are, from left to right and top to bottom: fast rewind, play, fast forward, compress and archive or transmit, exit, get help, stop, pause, pan, compress and archive or transmit (the same icon again because it extends into second row), search folders, and minimize. Other embodiments could offer different activation functions and/or offer activation functions using different symbols on one or more icons. Note that the gaps 224, sizes 230, and order 232 of components 206 changed from FIG. 20 to FIG. 21, and that FIG. 21 includes some different components 206 than FIG. 20, to illustrate some of the ways in which UIA code 414 may adapt an interface 122.

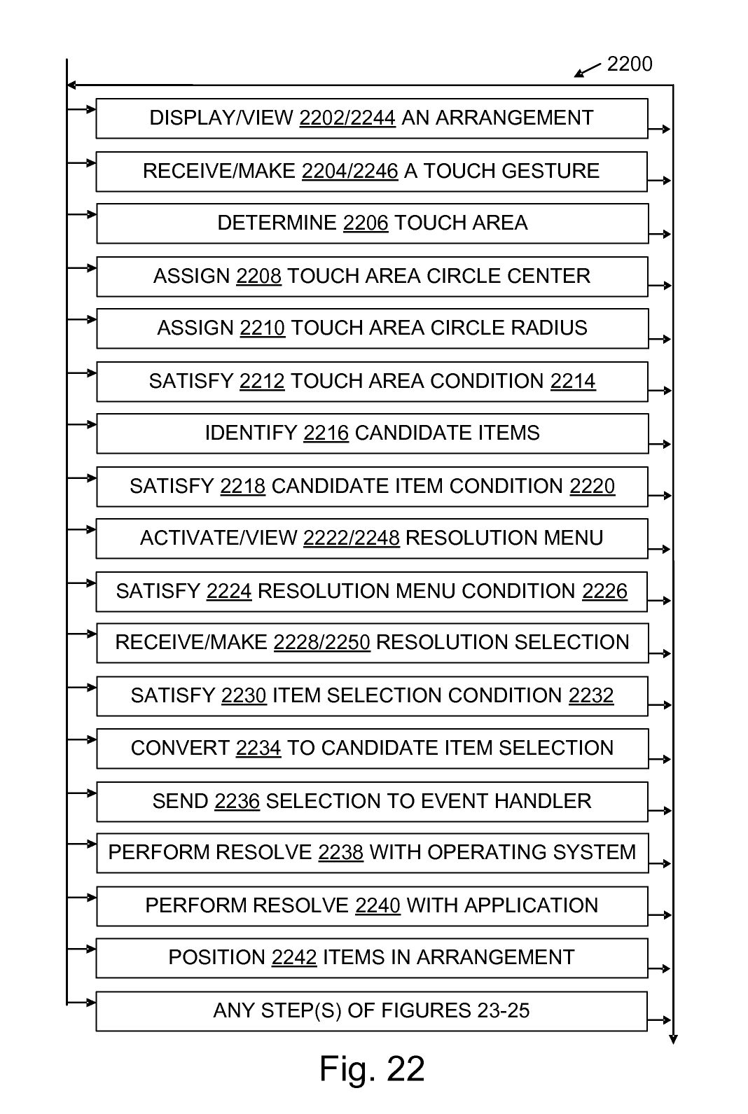

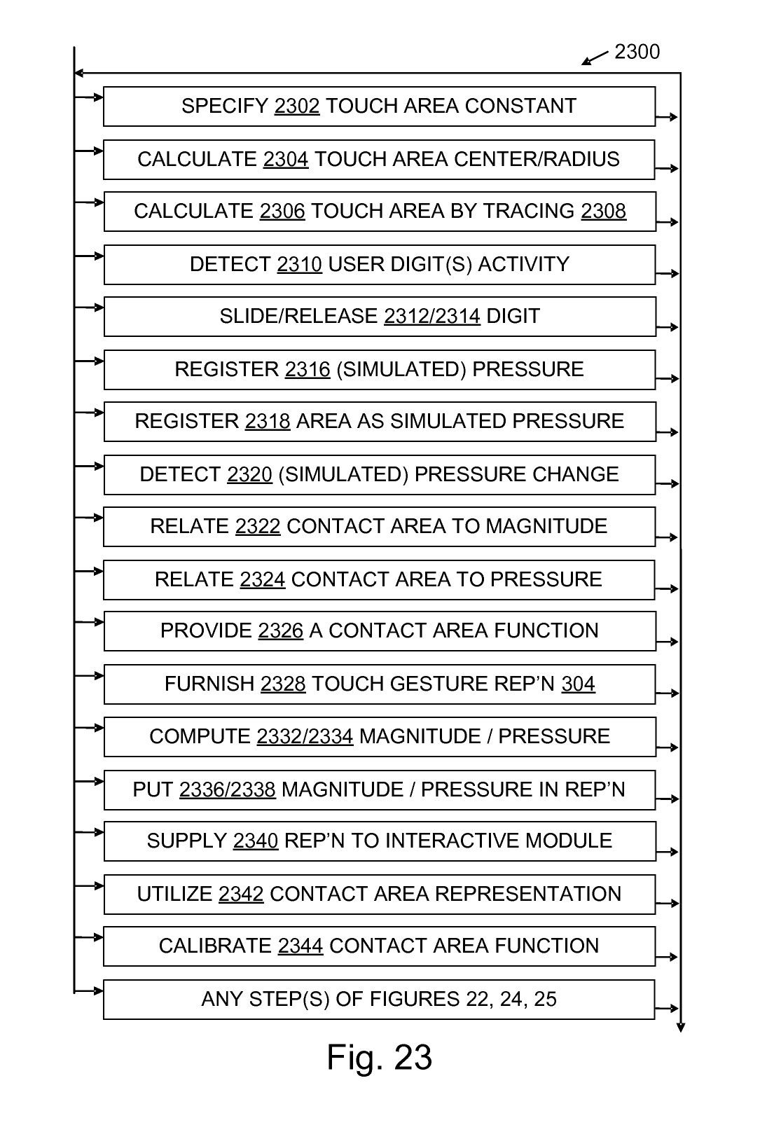

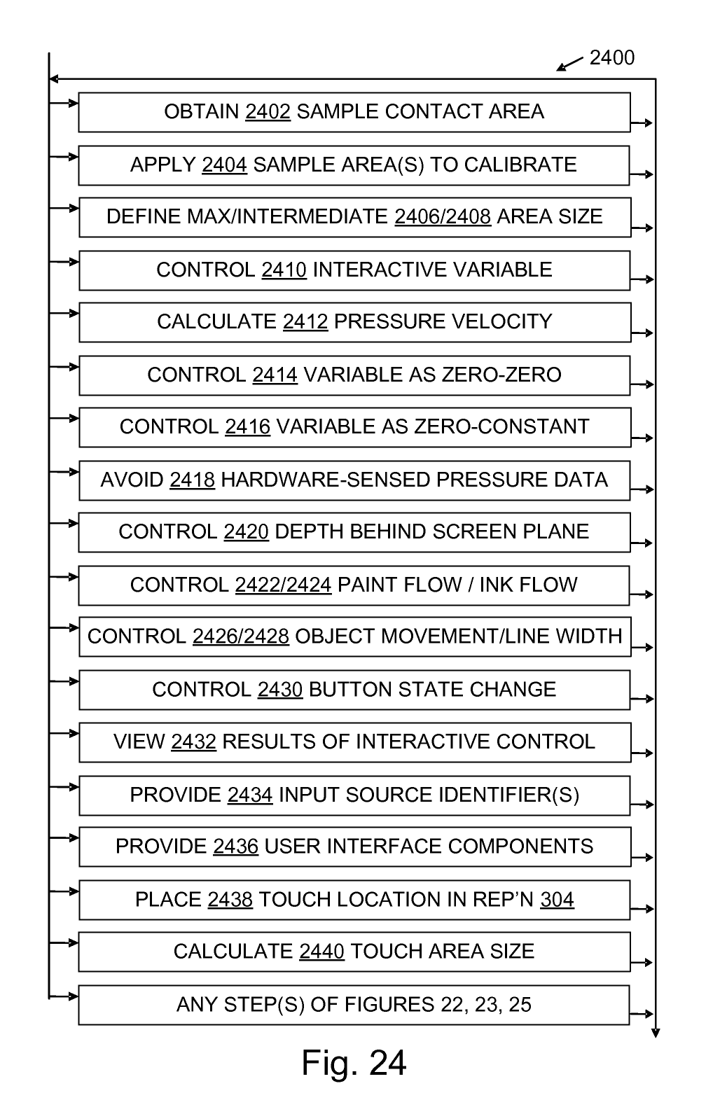

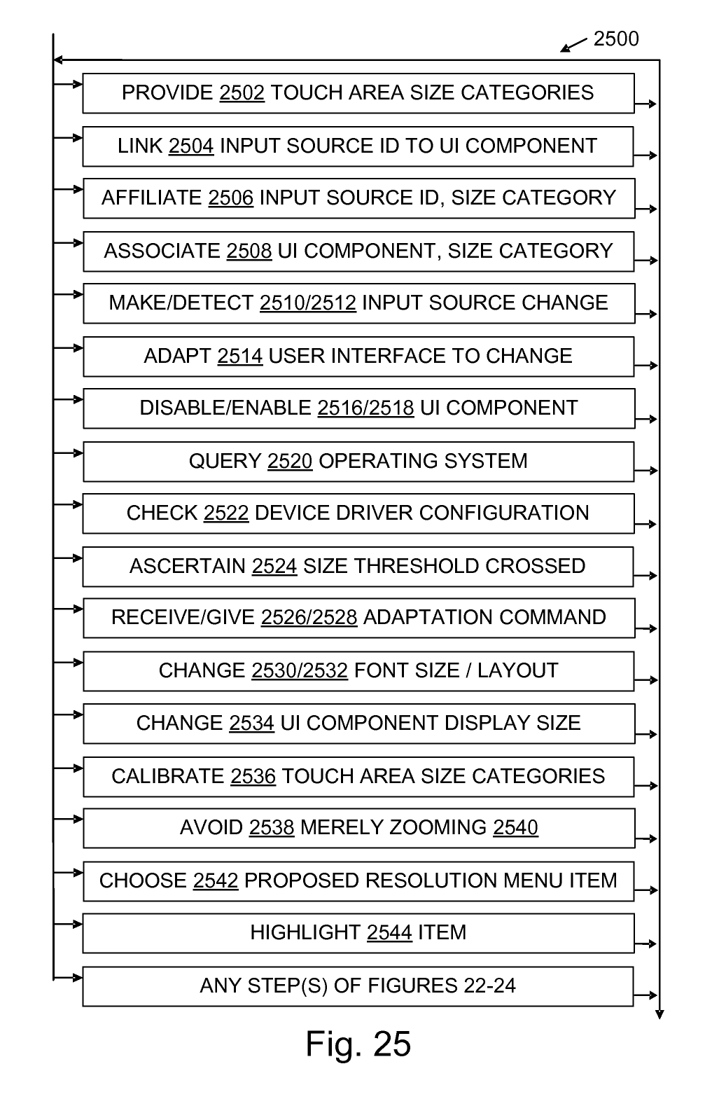

FIGS. 22 through 25 further illustrate some process embodiments. These Figures are organized in respective flowcharts 2200, 2300, 2400 and 2500. Technical processes shown in the Figures or otherwise disclosed may be performed in some embodiments automatically, e.g., under control of a script or otherwise requiring little or no contemporaneous live user input. Processes may also be performed in part automatically and in part manually unless otherwise indicated. In a given embodiment zero or more illustrated steps of a process may be repeated, perhaps with different parameters or data to operate on. Steps in an embodiment may also be done in a different order than the top-to-bottom order that is laid out in FIGS. 22 through 25. Steps may be performed serially, in a partially overlapping manner, or fully in parallel. The order in which one or more of the flowcharts 2200, 2300, 2400 and 2500 is traversed to indicate the steps performed during a process may vary from one performance of the process to another performance of the process. The flowchart traversal order may also vary from one process embodiment to another process embodiment. A given process may include steps from one, two, or more of the flowcharts. Steps may also be omitted, combined, renamed, regrouped, or otherwise depart from the illustrated flow, provided that the process performed is operable and conforms to at least one claim.

The steps shown in flowcharts 2200, 2300, 2400 and 2500 are described below, in the context of embodiments which include them, after a brief discussion of configured storage media. Examples are provided to help illustrate aspects of the technology, but the examples given within this document do not describe all possible embodiments. Embodiments are not limited to the specific implementations, arrangements, displays, features, approaches, or scenarios provided herein. A given embodiment may include additional or different technical features, mechanisms, and/or data structures, for instance, and may otherwise depart from the examples provided herein.

Configured Storage Media

Some embodiments include a configured computer-readable storage medium 112. Medium 112 may include disks (magnetic, optical, or otherwise), RAM, EEPROMS or other ROMs, and/or other configurable memory, including in particular computer-readable media (as opposed to mere propagated signals). The storage medium which is configured may be in particular a removable storage medium 114 such as a CD, DVD, or flash memory. A general-purpose memory, which may be removable or not, and may be volatile or not, can be configured into an embodiment using items such as resolution menus 236, ATR code 242, touch area representations 302, functions 312, 314 and other ABI code 306, pressure velocity 316, linkages 406, affiliations 408, associations 412, input-source-specific user interface components 206, and UIA code 414, in the form of data 118 and instructions 116, read from a removable medium 114 and/or another source such as a network connection, to form a configured medium. The configured medium 112 is capable of causing a computer system to perform technical process steps for ambiguous touch resolution, area-based interaction, or user interface adaptation, as disclosed herein. Figures thus help illustrate configured storage media embodiments and process embodiments, as well as system and process embodiments. In particular, any of the process steps illustrated in FIGS. 22 through 25, or otherwise taught herein, may be used to help configure a storage medium to form a configured medium embodiment.

Additional Examples Involving Ambiguous Touch Resolution

Some embodiments provide a computational process for resolving ambiguous touch gestures 202, including steps such as the following. A device or other system 102 displays 2202 an arrangement 220 of user interface items 206, which a user 104 views 2244. The user makes 2246 a touch gesture 202, which the system 102 receives 2204. FIG. 10 illustrates a user making 2246 a touch gesture. The system 102 automatically determines 2206 a touch area 204 of the touch gesture that was received on a screen 120 displaying the user interface 122 arrangement of user interface items 206. FIGS. 11 and 12 illustrate two of the many ways taught herein for determining 2206 a touch area 204. The items 206 are positioned 2242 relative to one another. The system 102 automatically identifies 2216 multiple candidate items 208 based on the touch area. Each candidate item 208 is a user interface item 206, but in general at a given point in time not every user interface item 206 is a candidate item 208.

Continuing this example, the system 102 automatically activates 2222 a resolution menu 236 which the user views 2248. The resolution menu 236 contains at least two resolution menu items 238. Each resolution menu item 238 has a corresponding candidate item 208. As illustrated, for example, in FIG. 13, the resolution menu items 238 are displayed at least partially outside the touch area, which in this example would be near the finger 502 tip and the gap 224 and would not extend to cover items 238. The resolution menu items 238 are displayed 2202 in a resolution menu arrangement 220 having resolution menu items positioned 2242 relative to one another differently than how the corresponding candidate items 208 are positioned relative to one another in the user interface arrangement. For example, the gap 224 between the resolution menu folder search and exit items 238 in FIG. 13 is relatively large compared to the gap between the corresponding user interface folder search and exit items 206 in FIG. 10.

Continuing this example, the system 102 receives 2228 a resolution menu item selection 240 made 2250 by the user, which selects at least one of the displayed resolution menu items 238. For example, the user may tap the exit icon 238, or slide a finger toward that icon. Then the system 102 ATR code 242 computationally converts 2234 the resolution menu item selection 240 into a selection 234 of the candidate item 208 which corresponds to the selected resolution menu item 238. For example, the system may keep a table, list, or other data structure 132 of item identifier pairs memorializing the correspondence between candidate items 208 and respective resolution menu items 238, and do conversion 2234 by searching that data structure 132. Alternately, each candidate item 208 and respective resolution menu item 238 may be a different manifestation of the same underlying activation function 336 data structure 132. Other implementations may also be used in some embodiments.

In some embodiments, the ambiguous touch resolution process is performed 2238 at least in part by an operating system 130. In some of these, the process further includes the operating system sending 2236 the selection 234 of the candidate item to an event handler 246 of an application program 124. This architecture allows legacy applications to upgrade to gain the ambiguous touch resolution capability by invoking a different event handler and/or operating system that has the ATR code 242. In some embodiments, the ambiguous touch resolution process is performed 2240 at least in part by an application program 124. In other words the ATR code 242 may reside in an operating system 130, in an application 124, or in both.

In some embodiments, the resolution menu items 238 are displayed in a resolution menu arrangement having resolution menu items positioned 2242 relative to one another differently than how the corresponding candidate items are positioned relative to one another in the user interface arrangement in at least one of the ways described below.

In some embodiments, the positions 222 satisfy 2224 a condition 2226 that a first gap 224 between resolution menu items is proportionally larger in the resolution menu arrangement than a second gap 224 between corresponding candidate items in the user interface arrangement. In some, the positions 222 satisfy 2224 a condition 2226 that a first gap 224 between resolution menu items is proportionally smaller in the resolution menu arrangement than a second gap 224 between corresponding candidate items in the user interface arrangement.

In some embodiments, the positions 222 satisfy 2224 a condition 2226 that edges 226 of candidate items which are aligned in the user interface arrangement have corresponding edges 226 of resolution menu items which are not aligned in the resolution menu arrangement. In some, the positions 222 satisfy 2224 a condition 2226 that edges 226 of candidate items which are not aligned in the user interface arrangement have corresponding edges 226 of resolution menu items which are aligned in the resolution menu arrangement.

In some embodiments, the positions 222 satisfy 2224 a condition 2226 that candidate items which appear the same size 230 as each other in the user interface arrangement have corresponding resolution menu items which do not appear the same size 230 as one another in the resolution menu arrangement. In some, the positions 222 satisfy 2224 a condition 2226 that candidate items which do not appear the same size 230 as each other in the user interface arrangement have corresponding resolution menu items which appear the same size 230 as one another in the resolution menu arrangement.

In some embodiments, the positions 222 satisfy 2224 a condition 2226 that a first presentation order 232 of resolution menu items is different in the resolution menu arrangement than a second presentation order 232 of corresponding candidate items in the user interface arrangement.

In some embodiments, the touch area determining step 2206 includes determining the touch area as a circular area having a center 212 and a radius 214. In some, at least one of the touch area conditions 2214 discussed below is satisfied 2212. Note that touch area determination 2206 is an example of an aspect of the innovations herein that can be used not only in ATR code 242 but also in ABI code 306 and in UIA code 414.

One condition 2214 specifies that the center 212 is at a touch location 216 of the received touch gesture 202. Another condition 2214 specifies that the center 212 is at a previously specified 2302 offset from a touch location of the received touch gesture. The offset may be vendor-specified or user-specified. Another condition 2214 specifies that the center 212 is calculated 2304 at least in part from multiple touch locations 216 of the received touch gesture, as shown for instance in FIG. 12. The assigned 2208 center 212 may be calculated 2304, for instance, as an average of multiple touch locations 216, or as a weighted average in which outliers have less weight.

One condition 2214 specifies that the radius 214 is specified 2302 prior to receiving 2204 the touch gesture. The radius may be vendor-specified or user-specified. Another condition 2214 specifies that the radius 214 is calculated 2304 at least in part from multiple touch locations 216 of the received touch gesture. The assigned 2210 radius 214 may be calculated 2304, for instance, as an average of one-half the distances between several pairs of touch locations 216.

One condition 2214 specifies that the touch area 204 is a rectangular area; one condition specifies a quadrilateral such as the FIG. 7 example. One condition 2214 specifies that the touch area is calculated 2306 at least in part by tracing 2308 through multiple touch locations of the received touch gesture; irregularly shaped touch areas like those shown in FIG. 8 and FIG. 9 may be obtained by tracing through some of the outermost touch locations 216, for example. One condition 2214 specifies that the touch area is neither a circle nor a rectangle.

In some embodiments, selections satisfy 2230 a condition 2232. In some, for example, a satisfied condition 2232 specifies that a user interface item 206 is identified 2216 as a candidate item because the touch area 204 covers more than a predetermined percentage of the displayed user interface item 206. In FIG. 11, for example, the touch area circle 210 covers at least 15% of each of the two candidate items 208. Other thresholds may also be used, e.g., 10%, 20%, 30%, one third, 40%, 50%, and intervening thresholds.

In some embodiments, a satisfied condition 2232 specifies that a user interface item is identified 2216 as a candidate item because more than a predetermined number of touch locations 216 of the touch gesture are within the touch area and also within the displayed user interface item. In the example of FIG. 12, each candidate item's screen display area contains at least three touch locations 216 that are also within the touch area circle 210. Other thresholds may also be used, e.g., at least 1, at least 2, at least 4, at least 5, or at least a predetermined percentage of the total number of touch locations.

In some embodiments, a satisfied condition 2232 specifies that touch locations 216 of the touch gesture have respective weights, and a user interface item is identified 2216 as a candidate item because a total of the weights of touch locations of the touch gesture within the displayed user interface item exceeds a predetermined weight threshold.

Bearing in mind that “digit” means a finger or a thumb, in some embodiments, a satisfied condition 2232 specifies that receiving 2228 a resolution menu item selection includes detecting 2310 a user sliding 2312 a digit 502 in contact with the screen 120 toward the resolution menu item and then releasing 2314 that digit from contact with the screen.

In some embodiments, a satisfied condition 2232 specifies that a resolution menu item continues to be displayed 2202 after a digit touching the screen is released 2314 from contact with the screen, and receiving a resolution menu item selection includes detecting 2310 a user then touching 2246 the screen at least partially inside the resolution menu item 238.

In some embodiments, selection of the resolution menu item 238 occurs while a user has at least one digit 502 in contact with the screen at a screen location outside the resolution menu item 238, and receiving a resolution menu item selection includes detecting 2310 the user touching the screen at least partially inside the resolution menu item with at least one other digit.

In some embodiments, the process further includes automatically choosing 2542 a proposed resolution menu item and highlighting 2544 it in the user interface, and receiving a resolution menu item selection includes automatically selecting 240 the proposed resolution menu item after detecting 2310 a user removing all digits from contact with the screen for at least a predetermined period of time. For example, the item 238 whose candidate item 208 has the most touch locations 216 in its display, or the one who overlaps the largest portion of the contact area, could be automatically selected and highlighted. It would then be chosen after two seconds, or three seconds, or five seconds, or another predetermined time passes without the user selecting a different item 238.

Some embodiments provide a computer-readable storage medium 112 configured with data 118 (e.g., data structures 132) and with instructions 116 that when executed by at least one processor 110 causes the processor(s) to perform a technical process for resolving ambiguous touch gestures. In general, any process illustrated in FIGS. 22-25 or otherwise taught herein which is performed by a system 102 has a corresponding computer-readable storage medium embodiment which utilizes the processor(s), memory, screen, and other hardware according to the process. Similarly, computer-readable storage medium embodiments have corresponding process embodiments.

For example, one process includes a screen of a device 102 displaying 2202 multiple user interface items in a pre-selection user interface arrangement in which the user interface items are positioned relative to one another, the screen 120 in this case also being a touch-sensitive display screen. The device receives 2204 a touch gesture on the screen. The device automatically determines 2206 a touch area of the touch gesture. The device automatically identifies 2216 multiple candidate items based on the touch area; each candidate item is a user interface item and the candidate items are positioned relative to one another in the pre-selection user interface arrangement. The device automatically activates 2222 a resolution menu which contains at least two resolution menu items. Each resolution menu item has a corresponding candidate item. The resolution menu items are displayed at least partially outside the touch area. The resolution menu items are also displayed in a pre-selection resolution menu arrangement in which the resolution menu items are positioned 2242 relative to one another differently than how the corresponding candidate items are positioned relative to one another in the pre-selection user interface arrangement with respect to at least one of relative gap size, relative item size, item edge alignment, or presentation order. The device receives 2228 a resolution menu item selection which selects at least one of the displayed resolution menu items. Then the device computationally converts 2234 the resolution menu item selection into a selection of the candidate item which corresponds to the selected resolution menu item.

In some computer-readable storage medium embodiments, the process further includes an operating system sending 2236 the selection of the candidate item to an event handler of an application program. In some, a user interface item is identified 2216 as a candidate item because the touch area covers more than a predetermined percentage of the displayed user interface item. In some, a user interface item is identified 2216 as a candidate item because more than a predetermined number of touch locations of the touch gesture are within the touch area and also within the displayed user interface item. In some, one or more of the touch area conditions 2214, candidate item conditions 2220, resolution menu conditions 2226, or item selection conditions 2232 are satisfied 2212, 2218, 2224, 2230, respectively, and the process proceeds as discussed herein in view of those conditions.

Some embodiments provide a device 102 that is equipped to resolve ambiguous touch gestures. The device includes a processor 110, a memory 112 in operable communication with the processor, a touch-sensitive display screen 120 displaying a user interface arrangement of user interface items positioned relative to one another, and ambiguous touch resolution logic 128, or functionally equivalent software such as ATR code 242 residing in the memory and interacting with the processor and memory upon execution by the processor to perform a technical process for resolving ambiguous touch gestures.

In some embodiments, the process includes the steps of: (a) determining 2206 a touch area of a touch gesture that was received on the screen, (b) identifying 2216 multiple candidate items based on the touch area, wherein each candidate item is a user interface item, (c) displaying 2202 on the screen a resolution menu which contains at least two resolution menu items, wherein each resolution menu item has a corresponding candidate item, the resolution menu items are displayed at least partially outside the touch area, the resolution menu items are displayed in a resolution menu arrangement having resolution menu items positioned relative to one another differently than how the corresponding candidate items are positioned relative to one another in the user interface arrangement with respect to at least one of relative gap size, relative item size, item edge alignment, or presentation order, (d) receiving 2228 a resolution menu item selection which selects at least one of the displayed resolution menu items, and (e) converting 2234 the resolution menu item selection into a selection of the candidate item which corresponds to the selected resolution menu item.

In some embodiments, the touch-sensitive display screen 120 is also pressure-sensitive. In some, the touch area 204 has a radius or other size measurement which is calculated at least in part from a pressure 1702 of the touch gesture that was registered 2316 by the screen. In some, receiving a resolution menu item selection includes detecting 2320 a pressure change directed toward the resolution menu item by at least one digit 502.

In some device embodiments, one or more of the touch area conditions 2214, candidate item conditions 2220, resolution menu conditions 2226, or item selection conditions 2232 are satisfied, and the device operates accordingly on the basis of the satisfied condition(s).

Additional Examples Involving Area-Based Interaction

Some embodiments provide a computational process for area-based interaction, e.g., for assisting user 104 interaction with a device 102 having a touch screen 120, including steps such as the following. A vendor, user, operating system, logic, or other entity provides 2326 in the device 102 an area-to-magnitude function 312 which monotonically relates 2322 non-zero contact area sizes to corresponding touch magnitude values 310. Also furnished 2328 within a memory of the device is a data structure 132 which structurally defines digital representations 304 of touch gestures. The device receives 2204 a touch gesture within a contact area on the touch screen. The contact area has a contact area size 218 and includes at least one touch location 216. The device computes 2332 at least one non-zero touch magnitude value which represents at least one magnitude of the touch gesture. The touch magnitude value is computed 2332 using the function 312 which monotonically relates non-zero contact area sizes to corresponding touch magnitude values.

Continuing this example, the process puts 2336 the touch magnitude value in a digital representation of the touch gesture. This process also places 2438 at least one touch location value in the digital representation of the touch gesture, the touch location value representing at least one touch location located within the contact area. Finally, this example process supplies 2340 the digital representation of the touch gesture to an interactive module 320 of the device as a user input 318.

In some embodiments, the process further includes calculating 2440 the contact area size by utilizing 2342 at least one of the following representations 302 of the contact area 204: a circular area having a center 212 and a radius 214, a rectangular area defined using four vertex points 702, a quadrilateral area defined using four vertex points 702, a convex polygonal area having vertex points 702, a bitmap, or a set of discrete points inside the contact area (the boundary is included, so points “inside” may be on the boundary).

In some embodiments, the process includes calculating 2440 the contact area size utilizing a representation of the contact area as a circular area having a center and a radius, and assigning 2208 one of the following values as the center 212: a touch location, a predefined offset from a touch location, or an average of multiple touch locations. Some embodiments include assigning 2210 one of the following values as the radius 214: a radius value specified by a user setting, a radius value specified by a device default setting, or a computational combination of multiple distance values which are derived from multiple touch locations.

In some embodiments, the area-to-magnitude function 312 which monotonically relates non-zero contact area sizes to corresponding touch magnitude values is a discontinuous step function. In some, the area-to-magnitude function 312 is a continuous function.

In some embodiments, the process supplies 2340 the digital representation as a user input in which the touch magnitude value represents at least part of at least one of the following: a pressure 1702, or a pressure velocity 316.

In some embodiments, the process includes calibrating 2344 the area-to-magnitude function 312 which monotonically relates non-zero contact area sizes to corresponding touch magnitude values. Calibration includes obtaining 2402 at least one sample contact area and applying 2404 the sample contact area(s) as calibration input(s). FIGS. 14 and 15 illustrate application of obtained samples to calibrate 2344 by selecting a curve near or through the obtained samples.

In some embodiments, the process includes an interactive module controlling 2410 at least one of the following user-visible interactive variables 322 based on the supplied digital representation of the touch gesture: a depth 324 behind a plane defined by the touch screen 120, a paint flow 326, an ink flow 328, a rendered object 1602 movement 330, a rendered line width 332, or state changes in a user interface button 206 which has at least three states 334.

Some embodiments provide a computer-readable storage medium 112 configured with data 118 (e.g., data structures 132) and with instructions 116 that when executed by at least one processor 110 causes the processor(s) to perform a technical process for assisting interaction with a system which includes a touch screen. Some processes include providing 2326 in the system an area-to-pressure function 314 which monotonically relates 2324 at least two non-zero contact area sizes to corresponding simulated pressure values 308. Some include furnishing 2328 within a memory of the system a data structure which structurally defines digital representations of touch gestures, and receiving 2204 a touch gesture within a contact area on the touch screen, the contact area having a non-zero contact area size. Some include computing 2334 at least one non-zero simulated pressure value for the touch gesture by using the area-to-pressure function 314 which monotonically relates non-zero contact area sizes to corresponding simulated pressure values. Some include putting 2338 the simulated pressure value in a digital representation of the touch gesture. Some include supplying 2340 the digital representation of the touch gesture to an interactive module of the device as a user input.

Given the task of implementing an area-to-magnitude function 312 or an area-to-pressure function 314, one of skill will recognize that a variety of suitable implementations can be made. Some of the many possible implementations are described below using example values. Thus, in some embodiments, the area-to-pressure function 314 is characterized in at least one of the ways described below. Note that similar characterizations are readily applied by one of skill to ascertain some area-to-magnitude function 312 implementation possibilities.

The function is a discontinuous step function which monotonically relates contact area sizes to corresponding simulated pressure values that include a low pressure, a medium pressure, and a high pressure.

The function monotonically relates the following contact area sizes to different respective simulated pressure values: 0.4 cm², 0.6 cm², and 0.8 cm².

The function monotonically relates the following contact area sizes to different respective simulated pressure values: 0.5 cm², 0.7 cm², and 0.9 cm².

The function monotonically relates the following contact area sizes to different respective simulated pressure values: 0.5 cm², 0.75 cm², and 1.0 cm².

The function monotonically relates the following contact area sizes to different respective simulated pressure values: 0.5 cm², 0.9 cm², and 1.2 cm².

The function monotonically relates the following contact area sizes to different respective simulated pressure values: 0.5 cm², 1.0 cm², and 1.5 cm².

The function monotonically relates the following contact area sizes to different respective simulated pressure values: 0.5 cm², 1.0 cm², and 2.0 cm².

The function monotonically relates the following contact area sizes to different respective simulated pressure values: 1.0 cm², 2.0 cm², and 3.0 cm².

For at least one of the following sets of two or more contact area sizes, the function implementation relates each of the contact area sizes in the set to a different respective simulated pressure value: 0.25 cm², 0.4 cm²; 0.3 cm², 0.45 cm²; 0.3 cm², 0.5 cm²; 0.4 cm², 0.5 cm²; 0.4 cm², 0.6 cm²; 0.4 cm², 0.7 cm²; 0.4 cm², 0.8 cm²; 0.4 cm², 0.9 cm²; 0.5 cm², 0.7 cm²; 0.5 cm², 0.8 cm²; 0.5 cm², 0.9 cm²; 0.6 cm², 0.8 cm²; 0.6 cm², 0.9 cm²; 0.7 cm², 0.9 cm²; 0.7 cm², 1.0 cm²; 0.7 cm², 1.1 cm²; 0.8 cm², 1.2 cm²; 0.8 cm², 1.3 cm²; 0.9 cm², 1.4 cm²; 0.4 cm², 0.6 cm², and 0.8 cm²; 0.5 cm², 0.7 cm², and 0.9 cm²; 0.5 cm², 0.75 cm², and 1.0 cm²; 0.5 cm², 0.9 cm², and 1.2 cm²; 0.5 cm², 1.0 cm², and 1.5 cm²; 0.5 cm², 1.0 cm², and 2.0 cm²; or 1.0 cm², 2.0 cm², and 3.0 cm².

For at least three of the following contact area size thresholds, the function implementation relates two contact area sizes that are separated by the threshold to two different respective simulated pressure values: 0.1 cm², 0.2 cm², 0.25 cm², 0.3 cm², 0.35 cm², 0.4 cm², 0.45 cm², 0.5 cm², 0.55 cm², 0.6 cm², 0.65 cm², 0.7 cm², 0.75 cm², 0.8 cm², 0.85 cm², 0.9 cm², 0.95 cm², 1.0 cm², 1.1 cm², 1.2 cm², 1.3 cm², 1.4 cm², 1.5 cm², 1.6 cm², 1.7 cm², 1.8 cm², 1.9 cm², 2.0 cm², 2.2 cm², 2.4 cm², 2.6 cm², 2.8 cm², or 3.0 cm².

In some embodiments, calibrating 2344 an area-to-magnitude function 312 or an area-to-pressure function 314 includes defining 2406 a maximum contact area size for a particular user in part by obtaining 2402 a sample high pressure touch from that user 104. In some, calibrating 2344 includes defining 2408 an intermediate contact area size for a particular user in part by obtaining a sample intermediate pressure touch from that user.

Some embodiments include calculating 2412 a pressure velocity 316, which is defined as a change in contact area sizes divided by a change in time. Some embodiments control 2410 at least one user-visible interactive variable 322 based on the pressure velocity. One form of such control 2410, denoted here as zero-zero control 2414, is further characterized in some embodiments in that when pressure velocity goes to zero, the user-visible interactive variable also goes to zero. Another form of control 2410, denoted here as zero-constant control 2416, is further characterized in that when pressure velocity goes to zero, the user-visible interactive variable remains constant.

For example, assume ink flow is controlled 2410 by pressure velocity and ink flow goes to zero when pressure velocity goes to zero. Ink will start to flow when the user presses on the screen 120 with a fingertip (for instance; other devices 140 may be used instead), but will stop if the user then leaves the fingertip unmoving in place on the screen, thereby making the pressure velocity zero. By contrast, assume now that ink flow remains constant when pressure velocity goes to zero. Ink will similarly start to flow when the user presses on the screen 120 with a fingertip, and will continue to flow at the same rate when the fingertip stops moving and rests in place on the screen. As illustrated, for example, in FIG. 18, in some embodiments while a stroke is stationary, the actual ink coverage area can be bigger than the touch area, after taking ink flow rate into account. Similar results are provided when the fingertip is moving in two dimensions but area/pressure is constant. Other interactive variables 322 can be similarly controlled 2410.

In some embodiments, a system 102 has input hardware which includes at least the touch screen 120 and also includes any pointing device 140 that is present in the system. In some systems 102, none of the system input hardware produces pressure data per se from the touch gesture 202. For instance, the touch screen may be a conventional capacitive screen that registers touch but does not register pressure. In some such systems, contact area data from a registered 2318 touch gesture can be used to compute 2334 a simulated pressure value 308, e.g., by invoking an area-to-pressure function 314. Some systems 102 contain neither a pressure-sensitive screen 120, nor a pressure-sensing pen 140, nor any other source of pressure data. As taught herein, a simulated pressure value 308 can be computed even in systems that avoid 2418 components that provide hardware-sensed pressure data.

Some embodiments provide a system 102 equipped to interpret touch screen contact area as simulated pressure. The system includes a processor 110, a memory 112 in operable communication with the processor, and a touch-sensitive display screen 120 in operable communication with the processor. A function 314 implementation operates to monotonically relate 2324 at least three non-zero contact area sizes to corresponding simulated pressure values. Pressure simulation code (an example of ABI code 306) resides in the memory and interacts with the processor, screen, and memory upon execution by the processor to perform a technical process for interpreting a touch screen contact area size as pressure indicator during interaction with a user. In some embodiments, the process includes computing 2334 at least one non-zero simulated pressure value for a touch gesture by using the function 314 implementation to map a contact area size 218 of the touch gesture to the simulated pressure value 308. In some, the process supplies 2340 the simulated pressure value to an interactive module 320 of the system (e.g., an application 124) as a user input to control a user-visible interactive variable 322.

Some embodiments calculate 2440 the contact area size as discussed elsewhere herein. In some device embodiments, one or more of the touch area conditions 2214 are satisfied, and the device operates accordingly on the basis of the satisfied condition(s). Some embodiments assign 2208 one of the following values as the center: a touch location, a predefined offset from a touch location, or an average of multiple touch locations. Some assign 2210 one of the following values as the radius: a radius value specified by a user setting, a radius value specified by a device default setting, or a computational combination of multiple distance values which are derived from multiple touch locations.

Additional Examples Involving User Interface Adaptation

Some embodiments provide a computational process for adapting a user interface in response to an input source change, e.g., through dynamic GUI resizing. Assume a user interface 122 is displayed on a touch-responsive screen 120 of a device 102 which also has a processor 110 and memory 112. In some embodiments, the process includes an entity providing 2434 in the device at least two input source identifiers 404 and at least two user interface components 206. Some processes link 2504 each of the input source identifiers with a respective user interface component in the memory. The device detects 2512 an input source change, from a first input source identifier linked with a first user interface component to a second input source identifier linked with a second user interface component. In response, the process adapts 2514 the user interface by doing at least one of the following: disabling 2516 a first user interface component which is linked with the first input source identifier and is not linked with the second input source identifier, or enabling 2518 a second user interface component which is not linked with the first input source identifier and is linked with the second input source identifier.

In some embodiments, the first input source identifier does not identify any input source that is identified by the second input source identifier, the first input source identifier identifies a digit 502 as an input source (recall that “digit” means at least one finger or at least one thumb), and the second input source identifier identifies at least one of the following pointing devices 140 as an input source: a mouse, a pen, a stylus, a trackball, a joystick, a pointing stick, a trackpoint, or a light pen.

In some embodiments, the process adapts 2514 the user interface in response to two consecutive inputs, and one of the following conditions is satisfied. Under a first condition, one input is from a digit and the other input is from a mouse, a pen, a stylus, a trackball, a joystick, a pointing stick, a trackpoint, or a light pen pointing device. Under the second condition, one input is from an adult's digit and the other input is from a child's digit.

In some embodiments, the first input source identifier identifies an input source which is elastic, and the second input source identifier identifies an input source which is not elastic. In some embodiments, “elastic” means producing touch areas of at least three different sizes which differ from one another in that each of the sizes except the smallest size is at least 30% larger than another of the sizes. In other embodiments, elastic is defined differently, e.g., based on a 20% difference in sizes, or based on a 25% difference, or a 35% difference, or a 50% difference, or a 75% difference, for example. In some situations, an elastic property of the input device is relatively unimportant in comparison to other properties, particularly if a user always touches the screen using the same force thus producing the same area each time. Area size 218 would change when usage changes as to the digit used (e.g., from thumb to index finger) or by passing the device to someone else who applies a different touch force (e.g., between an adult and a child). This case can be detected when the elastic device is changed, by obtaining 2402 sample points. Some embodiments require three different sizes be produced from the elastic device, while others do not. Some embodiments do not adapt the user interface merely because a user suddenly increases the touch force using the same finger.

In some embodiments, detecting 2512 an input source change made 2510 by a user includes querying 2520 an operating system 130 to determine a currently enabled input source 402. Some embodiments check 2522 which device driver 416 is configured in the device to supply input. Some keep a history of recent area sizes 218 and ascertain 2524 that a sequence of at least two touch area sizes has crossed a predefined touch area size threshold 418. Some can receive 2526 through the user interface a command given 2528 by the user which specifically states a change to a different input source identifier. For example, an adult user may command the device to adapt itself for use by a child.

In some embodiments, the process adapts 1524 the user interface at least in part by changing 2530 between a user interface component 206 that has a text font size 422 designed for use with a precise pointing device as the input source and a user interface component that has a text font size designed for use with a digit as the input source. As elsewhere, “digit” means at least one finger or at least one thumb, and in this context a “precise pointing device” means a mouse, a pen, a stylus, a trackball, a joystick, a pointing stick, a trackpoint, or a light pen.

In some embodiments, the process adapts 1524 the user interface at least in part by changing 2532 a user interface component layout 424. In some, the process adapts 1524 the user interface at least in part by changing 2534 a user interface component size and/or shape. For example, some embodiments display box-shaped components 206 when a mouse is identified as the current input source 402 and display circular components 206 when a finger is identified as the current input source 402. FIGS. 20 and 21 illustrate some changes 2532, 2534 in layout and component size.

Some embodiments provide a computer-readable storage medium 112 configured with data 118 (e.g., data structures 132) and with instructions 116 that when executed by at least one processor 110 causes the processor(s) to perform a technical process for adapting 2514 a user interface in response to an input source change. The user interface is displayed on a touch-responsive screen of a device 102. In some embodiments, the process includes providing 2502 in the device at least two touch area size categories 410, at least two input source identifiers 404, and at least two user interface components 206; affiliating 2506 each of the at least two input source identifiers with a single respective touch area size category in the device (e.g., in a data structure 132); and associating 2508 each of the at least two user interface components with at least one touch area size category in the device (e.g., in a data structure 132). In some embodiments, the device detects 2512 an input source change, from a first input source identifier affiliated with a first touch area size category to a second input source identifier affiliated with second touch area size category. In response, the device adapts 2514 the user interface by doing at least one of the following: disabling 2516 a first user interface component which is associated with the first touch area size category and is not associated with the second touch area size category, or enabling 2518 a second user interface component which is not associated with the first touch area size category and is associated with the second touch area size category.

Other processes described herein may also be performed. For example, in some embodiments, the process includes calibrating 2536 touch area size categories at least in part by obtaining 2402 sample touch areas as calibration inputs.

Some embodiments provide a device 102 that is equipped to adapt a user interface 122 in response to an input source change. The device includes a processor 110, a memory 112 in operable communication with the processor, and at least two input source identifiers 404 stored in the memory. The identifiers 404 may be names, addresses, handles, Globally Unique Identifiers (GUIDs), or other identifiers that distinguish between input sources. In some embodiments, at least one of the input source identifiers identifies a digit as an input source. The device 102 also includes a touch-sensitive display screen 120 displaying a user interface 122 that includes user interface components 206. User interface adaptation code 414 resides in the memory 112 and interacts with the processor 110 and memory upon execution by the processor to perform a technical process for adapting the user interface in response to an input source change. In some embodiments, the process includes (a) linking 2504 each of the at least two input source identifiers with a respective user interface component, (b) detecting 2512 an input source change from a first input source identifier linked with a first user interface component to a second input source identifier linked with a second user interface component, and (c) in response to the detecting step, adapting 2514 the user interface. Adapting 2514 includes at least one of the following: disabling 2516 (e.g., removing from user view) a first user interface component which is linked with the first input source identifier and is not linked with the second input source identifier, or enabling 2518 (e.g., making visible to the user) a second user interface component which is not linked with the first input source identifier and is linked with the second input source identifier.

Other processes described herein may also be performed. For example, in some embodiments the process calibrates 2536 input source change detection based on touch area size differences by using at least two and no more than six sample touch areas as calibration inputs. In some, the user interface has a displayed portion, and at least a portion of the displayed portion is not zoomed 2540 by the process which adapts the user interface. That is, the process avoids 2538 merely zooming the existing interface components, by also (or instead) changing 2530 font size and/or changing 2532 layout. In some embodiments, at least a portion of the displayed portion is not zoomed by the process which adapts 2514 the user interface, and the process changes 2534 a user interface component size relative to the displayed portion size.

Further Considerations

Additional details and design considerations are provided below. As with the other examples herein, the features described may be used individually and/or in combination, or not at all, in a given embodiment.

Those of skill will understand that implementation details in this document may pertain to specific code, such as specific APIs and specific sample programs, and thus need not appear in every embodiment. Those of skill will also understand that program identifiers and some other terminology used in discussing details are implementation-specific and thus need not pertain to every embodiment. Nonetheless, although they are not necessarily required to be present here, these details are provided because they may help some readers by providing context and/or may illustrate a few of the many possible implementations of the technology discussed herein.

The following discussion is derived from internal FCEIMDIDGR documentation. FCEIMDIDGR is an acronym for Fuzzy Click Elastic Interaction Multi-Dimensional Interaction Dynamic GUI Resizing, which refers to software being program implemented by Microsoft Corporation. Aspects of the FCEIMDIDGR software and/or documentation are consistent with or otherwise illustrate aspects of the embodiments described herein. However, it will be understood that FCEIMDIDGR documentation and/or implementation choices do not necessarily constrain the scope of such embodiments, and likewise that FCEIMDIDGR products and/or their documentation may well contain features that lie outside the scope of such embodiments. It will also be understood that the discussion below is provided in part as an aid to readers who are not necessarily of ordinary skill in the art, and thus may contain and/or omit details whose recitation below is not strictly required to support the present disclosure.

With regard to ambiguous gesture resolution, in some embodiments a Fuzzy Click feature can either be activated automatically by the OS, or manually activated by the user. In some embodiments, a finger click area is determined using a circle. A center point is calculated 2304 from the OS using an existing mean. A radius is then calculated 2304 such that the circle 201 completely covers the finger click area 204, as illustrated for instance in FIG. 5. In another embodiment, illustrated in FIG. 6, multiple clicking points 216 are determined from the touch area.

In some embodiments, visual GUI elements 206 potentially can be activated based on the user's apparent intent. Items 206 can be activated (selected), for example, if they either have more than X % of the visual GUI area covered, or if they are covered by more than Y touch points. Examples are illustrated in FIGS. 11 and 12. In some embodiments, a Fuzzy Click context menu (a.k.a. resolution menu 236) is activated when more than one visual GUI element 206 satisfies the activation condition.

One alternative embodiment is for an application 124 to determine the possible click intent rather than the OS 130 determining it. In this approach, upon receiving a click event sent 2236 from the OS, the application GUI control event handler 246 would determine the probability of the neighboring control activation based on the distances (in pixels) between the neighboring controls 206. When the distance is smaller than average half finger width (e.g., 5 mm or less), it is also likely the neighboring control is the intended target. As illustrated in FIG. 13, the potential GUI elements (candidates 208) are enlarged and displayed in a context menu outside the finger touch area by the OS. To activate the GUI element in the Fuzzy Click context menu (resolution menu item 238), one can either slide the finger toward the menu item then release the finger, or lift the finger from the original position and select a context menu item, for example. A touch event is then sent 2236 to the application GUI event handler by the OS. As another way to activate the GUI element in the Fuzzy Click context menu, one lifts the finger from the original position and then selects a context menu item. A touch event is then sent 2236 to the application GUI event handler.

Some embodiments provide a method (a.k.a. process) for handling ambiguous touch gestures in a user interface which is displayed on a touch-sensitive display screen, including determining a finger click area of the user interface for a touch gesture which is received by the user interface on the touch-sensitive display screen. One possible implementation has the finger touch area represented by a circular area having a center and a radius, calculated 2304 in one of the following ways.

The center 212 can be determined in one of the following ways: it is the touch point determined by the conventional mean; it is at a predefined offset from a touch location of the received touch gesture; or it is calculated as an average at least in part from multiple touch locations of the received touch gesture.

The radius 214 can be determined in one of the following ways: it is pre-defined, based on user setting or device default setting or learning of user gesture; or it is calculated as an average from multiple touch locations of the received touch gesture.

Another alternative is that the finger click area 204 is a polygonal area (e.g., rectangle or other quadrilateral) covered by four edge points, as illustrated in FIG. 7. Another alternative is that the finger click area has a general irregular shape, and the area is represented by its convex envelop using multiple points representing the external vertices of the convex envelope, as illustrated in FIGS. 8 and 9. Another alternative is that the finger click area is exposed directly as an bitmap. Another alternative uses multiple points 216 within the proximity of the touch area as the inputs, as illustrated in FIGS. 6 and 12.

The touch surface area 204, determined by one of the methods described herein or another method, is used in some embodiments to infer the pressure applied to the touch input device (e.g., finger, elastic pointed pen). The expansion or the contraction of the touch surface area can be used to infer the pressure applied to the touch area, using an area-to-pressure function 314, as discussed in connection with and illustrated in FIGS. 14 through 19, for example.

Some embodiments assume that when pressure is zero is there is no touch. Note that the pressure can be measured in discrete as well as continuous values, depending on the embodiment, and there are different ways of doing this as discussed herein.

With reference to FIGS. 14 and 15, in some embodiments pressure inference is done by ABI code 306 with the flexibility of using different curves. One way is to calculate from one single touch sample point (in addition to the point zero), as illustrated in FIG. 14. The user/system configures a typical touch surface area representing 1 pressure unit. From the zero pressure point to the 1 pressure point, different curves can be fitted.

A sample point can be obtained 2402 in a variety of ways. For example, in some embodiments preset levels of pressure (e.g., low, medium and high) have the touch surface area preconfigured (e.g., 0.5 cm²′, 1 cm²′, 2 cm²). In some embodiments, preset levels of pressure (e.g., low, medium and high) have a touch surface area based on the user configuration.

As illustrated in FIG. 15, a pressure inference curve of a function 314 can also be calculated from two touch sample points (in addition to point zero). The user/system configures a typical touch surface area representing 1 pressure unit and a max surface area representing max pressure. From the zero pressure point to these points, different curves can be fitted. A pressure inference curve can be preconfigured with the input devices, where the manufacturer of the device pre-samples area-pressure data points. When the device is installed, the pressure inference curve is already built into the driver.

In some embodiments, the touch area 204, or the touch pressure as determined by an area-to-pressure function 314, can be used to draw lines with a varying width. A line varies in controlled width as the touch surface area or pressure changes in its traveling path. Such a feature enables effects for Chinese and Japanese calligraphy, signatures, and different painting stroke styles, for example.

In some embodiments, the touch area 204, or the touch pressure as determined by an area-to-pressure function 314, control 2430 click buttons which have multiple or even continuous states 334. A click button can have multiple states (instead of just click and non-click) associated with different touch surface areas that select the button. Each state has an event handler that the OS can invoke performing different actions. The states can be discrete (e.g., Slow, Medium, and High) or continuous (e.g., a firing rate can be associated with the touch area size). Discrete states may be mapped to different event handlers, while a continuous form provides additional input on top of the event (e.g., rate of fire on a missile fire button).

With regard to Multi-Dimensional Interaction, in some embodiments a finger click area of the user interface for a touch gesture is computed as discussed herein.

In some embodiments, the touch area and pressure differences in two consecutive time slots are used to estimate the Pressure Velocity 316 of user gesture movement. In some, the pressure velocity is calculated by ABI code 306 using the two touch areas/pressures of two consecutive time slots, indicating whether the pressure in the z axis is increasing or reducing and how fast it is:

$$\begin{matrix}Pressure Velocity = δ Area / δ time \\ = ( Area ( t ) - Area ( t - 1 ) ) / \\ ( Time ( t ) - Time ( t - 1 ) )\end{matrix} \qquad ( 1 )$$

A positive value indicates the direction into the touch screen, in some embodiments, and negative indicates the direction out of the touch screen.

Velocity can also be a discretized in an embodiment's ABI code 306 by mapping to a specific range of δArea/δtime.

More generally, some embodiments calculate the velocity from pressures estimated using an area-to-pressure function 314, or obtained by hardware pressure sensors:

$$\begin{matrix}Pressure Velocity = δ Pressure / δ time \\ = ( Pressure ( t ) - Pressure ( t - 1 ) ) / \\ ( Time ( t ) - Time ( t - 1 ) )\end{matrix} \qquad ( 2 )$$

In some embodiments, the velocity can be provided as an additional parameter to the application 124 for control, or it can be combined with the area to infer the pressure. As an example, the touch area can be small, but because of the velocity, an embodiment's ABI code 306 may actually infer more pressure than would result from a finger resting on the touch screen. Different functions can be used to define the relationship between the area, velocity, and pressure dependent on an input device's elasticity property.

As illustrated in FIG. 16, in some embodiments touch area and pressure differences in two consecutive time slots are used to estimate the user finger movement in 3D. First, the movement in the X-Y plane of the screen's surface can be calculated using a conventional method through two points 216 from two touch areas or by using the surface touch areas 204 in the two consecutive time slots to calculate the 2D movement (in X and Y axes). For the Z-axis movement, some embodiments use pressure velocity 316 to calculate the Z position:

Z position(t)=Z position(t−1)+Pressure_Velocity(t−1)*(Time(t)−Time(t−1)) (3)

More generally, some embodiments use any monotonic function f in the above formula for the calculation, with the condition that f(0)=0

Z position(t)=Z position(t−1)+f(Pressure_Velocity(t−1))*(Time(t)−Time(t−1)) (4)

In these embodiments, when the velocity is negative, the Z-axis movement is negative as well. When the velocity is 0, the Z position remains the same. In this kind of embodiment, when the finger is removed from the screen, Z position returns to 0.

Another way to have 3D movement is to interpret the zero Pressure Velocity as constant Z-axis speed. First, movement in the X-Y plane is calculated as discussed above. For the Z-axis movement, some embodiments use Formula (4) above. However, when the finger remains fixed on the touch surface in these embodiments (i.e., δPressure=0), velocity is the same as before. So if V is the Pressure Velocity at time t just before the finger stops making pressure changes, then at any time t′>t before the pressure changes again, we have:

Z position(t′)=Z position(t)+V*(Time(t′)−Time(t)) (5)

In these embodiments, when the finger is removed from the screen 120, Z position remains stationary. With this kind of interpretation of touch surface area change and feedback viewed 2432 by a user 104, the user can control 2426 variables 322 to simulate the manipulation of 3D objects in 3D space using the estimated 3D finger movement, even without a holographic display or other 3D display.

As examples of an interactive module 320, a three-dimensional movement can be input 318 used in some embodiments for interacting with a game or other application 124. In games, it can be treated as an additional input representing a modification to a certain action, such as running at a faster speed rather than at a normal speed, or firing at a higher rate, or hitting a target harder. It also can be used for manipulating an animated 3D object in a natural and intuitive way rather than using a combination of mouse button down and key plus the mouse movement or pre-selecting a direction for the movement 330.

In some embodiments, a drawing line has a varying width 332 that is determined by the touch surface area. A line varies in width as the touch surface area changes in its traveling path. Such a feature enables viewed 2432 effects for Chinese calligraphy, Japanese kanji, cursive signatures, and different painting stroke styles, for example. FIG. 19 shows an example.

In addition to controlling 2428 the width of the stroke as a function of area/pressure from the input device, in some embodiments ink flow 328 may be controlled 2424 as a function of area/pressure. In Chinese calligraphy or water based painting, the ink flow rate can be calculated in an application. The paper material absorption rate may be modeled as a function of time. Independently of that, applications 124 may respond to an increase in the overlap between two areas 204 at different times, e.g., when it exceeds a certain percentage, e.g., as shown in two instances like FIG. 18 at different times. For example, consider a finger 502 stroke that is stationary in space but exerts with increased vertical pressure over time, so pressure velocity is positive. In the physical world this would result in an increased ink flow rate. In this example, ink flow 328 rate remains constant when there is no change in the area. Pressure velocity 316 may also be used to adjust the ink color density, e.g., an increase in the ink flow rate increases the color density.

In some embodiments, paint flow 326 may be controlled 2422 as a function of area/pressure. In some, an application 124 simulates oil-based painting. In addition to controlling the width of the stroke as a function of area/pressure from the input device, a paint flow rate variable 326 is directly related to the change in the pressure or (for simulated pressure), the change in contact area. When the overlapping change is zero, the paint flow rate is also zero. This simulates the effect of paint that is sticky. In comparison to some other embodiments, where the ink can continue to flow when the pressure/area is constant, in this example the paint flow rate increases only when there is an increase in pressure or area.

With regard to a dynamic GUI, some embodiments provide a process for determining the application and/or OS visual GUI object size for rendering. The process include determining a user's typical finger touch surface area size, by using techniques described herein to determine size 218 for a predetermined number of samples or over a predetermined period of time, and then averaging those samples. The OS/application then determines an optimal visual GUI object size and optimal distances between the elements 206. This allows the OS/application to dynamically adapt 2514 the sizes of the visual elements so they are closer to optimal for the finger or other input source 402. The visual GUI object size can be determined based on the finger touch surface area, and adaptation 2514 can be also applied in some embodiments to other input sources such as pointed device (e.g., stylus or pen), and a mouse. For instance, one embodiment adapts an interface 122 to (a) use of a mouse or pen, (b) use by a child, and (c) use by an adult. An interface adaptation example is illustrated in FIGS. 20 and 21.

### CONCLUSION

Although particular embodiments are expressly illustrated and described herein as processes, as configured media, or as systems, it will be appreciated that discussion of one type of embodiment also generally extends to other embodiment types. For instance, the descriptions of processes in connection with FIGS. 22-25 also help describe configured media, and help describe the technical effects and operation of systems and manufactures like those discussed in connection with other Figures. It does not follow that limitations from one embodiment are necessarily read into another. In particular, processes are not necessarily limited to the data structures and arrangements presented while discussing systems or manufactures such as configured memories.

Reference herein to an embodiment having some feature X and reference elsewhere herein to an embodiment having some feature Y does not exclude from this disclosure embodiments which have both feature X and feature Y, unless such exclusion is expressly stated herein. The term “embodiment” is merely used herein as a more convenient form of “process, system, article of manufacture, configured computer readable medium, and/or other example of the teachings herein as applied in a manner consistent with applicable law.” Accordingly, a given “embodiment” may include any combination of features disclosed herein, provided the embodiment is consistent with at least one claim.

Not every item shown in the Figures need be present in every embodiment. Conversely, an embodiment may contain item(s) not shown expressly in the Figures. Although some possibilities are illustrated here in text and drawings by specific examples, embodiments may depart from these examples. For instance, specific technical effects or technical features of an example may be omitted, renamed, grouped differently, repeated, instantiated in hardware and/or software differently, or be a mix of effects or features appearing in two or more of the examples. Functionality shown at one location may also be provided at a different location in some embodiments; one of skill recognizes that functionality modules can be defined in various ways in a given implementation without necessarily omitting desired technical effects from the collection of interacting modules viewed as a whole.

Reference has been made to the figures throughout by reference numerals. Any apparent inconsistencies in the phrasing associated with a given reference numeral, in the figures or in the text, should be understood as simply broadening the scope of what is referenced by that numeral. Different instances of a given reference numeral may refer to different embodiments, even though the same reference numeral is used.

As used herein, terms such as “a” and “the” are inclusive of one or more of the indicated item or step. In particular, in the claims a reference to an item generally means at least one such item is present and a reference to a step means at least one instance of the step is performed.

Headings are for convenience only; information on a given topic may be found outside the section whose heading indicates that topic.

All claims and the abstract, as filed, are part of the specification.

While exemplary embodiments have been shown in the drawings and described above, it will be apparent to those of ordinary skill in the art that numerous modifications can be made without departing from the principles and concepts set forth in the claims, and that such modifications need not encompass an entire abstract concept. Although the subject matter is described in language specific to structural features and/or procedural acts, it is to be understood that the subject matter defined in the appended claims is not necessarily limited to the specific technical features or acts described above the claims. It is not necessary for every means or aspect or technical effect identified in a given definition or example to be present or to be utilized in every embodiment. Rather, the specific features and acts and effects described are disclosed as examples for consideration when implementing the claims.

All changes which fall short of enveloping an entire abstract idea but come within the meaning and range of equivalency of the claims are to be embraced within their scope to the full extent permitted by law.

What is claimed is:

1. A computational process for adapting a user interface in response to an input source change, the user interface displayed on a touch-responsive screen of a device which also has a processor and memory, the process comprising the steps of:
providing in the device at least two input source identifiers and at least two user interface components;
linking each of the at least two input source identifiers with a respective user interface component in the memory;
the device detecting an input source change, from a first input source identifier linked with a first user interface component to a second input source identifier linked with a second user interface component; and
in response to the detecting step, adapting the user interface by doing at least one of the following: disabling a first user interface component which is linked with the first input source identifier and is not linked with the second input source identifier, or enabling a second user interface component which is not linked with the first input source identifier and is linked with the second input source identifier.

2. The process of claim 1, wherein the first input source identifier does not identify any input source that is identified by the second input source identifier, the first input source identifier identifies a digit as an input source, “digit” means at least one finger or at least one thumb, and the second input source identifier identifies at least one of the following pointing devices as an input source: a mouse, a pen, a stylus, a trackball, a joystick, a pointing stick, a trackpoint, or a light pen.

3. The process of claim 1, wherein “digit” means at least one finger or at least one thumb, wherein “pointing device” means a mouse, a pen, a stylus, a trackball, a joystick, a pointing stick, a trackpoint, or a light pen, and wherein the process adapts the user interface in response to two consecutive inputs and one of the following conditions is satisfied:
one input is from a digit and the other input is from a pointing device; or
one input is from an adult's digit and the other input is from a child's digit.

4. The process of claim 1, wherein the first input source identifier identifies an input source which is elastic, the second input source identifier identifies an input source which is not elastic, and “elastic” means producing touch areas of at least three different sizes which differ from one another in that each of the sizes except the smallest size is at least 30% larger than another of the sizes.

5. The process of claim 1, wherein detecting an input source change comprises at least one of the following:
querying an operating system to determine a currently enabled input source;
checking which device driver is configured in the device to supply input;
ascertaining that a sequence of at least two touch area sizes has crossed a predefined touch area size threshold; or
receiving through the user interface a command which specifically states a change to a different input source identifier.

6. The process of claim 1, wherein the process adapts the user interface at least in part by at least one of the following steps:
changing between a user interface component that has a text font size designed for use with a pointing device as the input source and a user interface component that has a text font size designed for use with a digit as the input source, wherein “digit” means at least one finger or at least one thumb, and wherein “pointing device” means a mouse, a pen, a stylus, a trackball, a joystick, a pointing stick, a trackpoint, or a light pen;
changing a user interface component layout;
changing a user interface component shape; or
changing a user interface component size.

7. A computer-readable storage medium configured with data and with instructions that when executed by at least one processor causes the processor(s) to perform a technical process for adapting a user interface in response to an input source change, the user interface displayed on a touch-responsive screen of a device, the process comprising the steps of:
providing in the device at least two touch area size categories, at least two input source identifiers, and at least two user interface components;
affiliating each of the at least two input source identifiers with a single respective touch area size category in the device;
associating each of the at least two user interface components with at least one touch area size category in the device;
the device detecting an input source change, from a first input source identifier affiliated with a first touch area size category to a second input source identifier affiliated with second touch area size category; and
in response to the detecting step, adapting the user interface by doing at least one of the following: disabling a first user interface component which is associated with the first touch area size category and is not associated with the second touch area size category, or enabling a second user interface component which is not associated with the first touch area size category and is associated with the second touch area size category.

8. The computer-readable storage medium of claim 7, wherein the first input source identifier identifies a digit input source, “digit” means at least one finger or at least one thumb, and the second input source identifier identifies at least one of the following pointing devices as an input source: a mouse, a pen, a stylus, a trackball, a joystick, a pointing stick, a trackpoint, or a light pen.

9. The computer-readable storage medium of claim 7, wherein the first input source identifier identifies an input source which is elastic, the second input source identifier identifies an input source which is not elastic, and “elastic” means producing touch areas of at least three different sizes which differ from one another in that each of the sizes except the smallest size is at least 20% larger than another of the sizes.

10. The computer-readable storage medium of claim 7, wherein detecting an input source change comprises at least one of the following:
querying an operating system to determine a currently enabled input source;
checking which device driver is configured in the device to supply input.

11. The computer-readable storage medium of claim 7, wherein detecting an input source change comprises ascertaining that a sequence of at least two touch area sizes has crossed a predefined touch area size threshold.

12. The computer-readable storage medium of claim 7, wherein the process further comprises calibrating touch area size categories at least in part by obtaining sample touch areas as calibration inputs.

13. The computer-readable storage medium of claim 7, wherein the process adapts the user interface at least in part by changing between a user interface component that has a text font size or a screen area size designed for use with a pointing device as the input source and a user interface component that has a text font size or a screen area size, respectively, that is designed for use with a digit as the input source, wherein “digit” means at least one finger or at least one thumb, and wherein “pointing device” means a mouse, a pen, a stylus, a trackball, a joystick, a pointing stick, a trackpoint, or a light pen.

14. A device equipped to adapt a user interface in response to an input source change, the device comprising:
a processor;
a memory in operable communication with the processor;
at least two input source identifiers stored in the memory, at least one of the input source identifiers identifying a digit as an input source, where “digit” means at least one finger or at least one thumb;
a touch-sensitive display screen displaying a user interface that includes user interface components;
user interface adaptation code residing in the memory and interacting with the processor and memory upon execution by the processor to perform a technical process for adapting the user interface in response to an input source change, including the steps of: (a) linking each of the at least two input source identifiers with a respective user interface component, (b) detecting an input source change from a first input source identifier linked with a first user interface component to a second input source identifier linked with a second user interface component, and (c) in response to the detecting step, adapting the user interface by doing at least one of the following: disabling a first user interface component which is linked with the first input source identifier and is not linked with the second input source identifier, or enabling a second user interface component which is not linked with the first input source identifier and is linked with the second input source identifier.

15. The device of claim 14, wherein the first input source identifier identifies a digit as an input source, wherein “digit” means at least one finger or at least one thumb, and wherein the second input source identifier identifies at least one of the following pointing devices as an input source: a mouse, a pen, a stylus, a trackball, a joystick, a pointing stick, a trackpoint, or a light pen.

16. The device of claim 14, wherein the process calibrates input source change detection based on touch area size differences by using at least two and no more than six sample touch areas as calibration inputs.

17. The device of claim 14, wherein detecting an input source change comprises at least one of the following:
querying an operating system to determine a currently enabled input source;
checking which device driver is configured in the device to supply input; or ascertaining that a sequence of at least two touch area sizes has crossed a predefined touch area size threshold.

18. The device of claim 14, wherein the user interface has a displayed portion, wherein at least a portion of the displayed portion is not zoomed by the process which adapts the user interface, wherein the process comprises changing between a user interface component that has a text font size designed for use with a pointing device as the input source and a user interface component that has a text font size designed for use with a digit as the input source, wherein “digit” means at least one finger or at least one thumb, and wherein “pointing device” means a mouse, a pen, a stylus, a trackball, a joystick, a pointing stick, a trackpoint, or a light pen.

19. The device of claim 14, wherein the user interface has a displayed portion, wherein at least a portion of the displayed portion is not zoomed by the process which adapts the user interface, and wherein the process comprises changing a user interface component layout of the displayed portion.

20. The device of claim 14, wherein the user interface has a displayed portion having a displayed portion size on the display screen, wherein at least a portion of the displayed portion is not zoomed by the process which adapts the user interface, and wherein the process comprises changing a user interface component size relative to the displayed portion size.
